(19) United States
(12) Patent Application Publication
(10) Pub. No.: US 2026/0227846 A1
(43) Pub. Date: Aug. 6, 2026

(54) USER INTERFACES AND TECHNIQUES FOR MANAGING USER ACTIVITY

(71) Applicant: Apple Inc., Cupertino, CA (US)

(72) Inventors: Agatha Y. YU, Oakland, CA (US); Gergo PALKOVICS, San Francisco, CA (US); Marisa R. LU, San Francisco, CA (US)

(21) Appl. No.: 19/531,585

(22) Filed: Feb. 5, 2026

Related U.S. Application Data
(60) Provisional application No. 63/755,241, filed on Feb. 6, 2025.
(60) Provisional application No. 63/976,819, filed on Feb. 5, 2026.

(51) Int. Cl. G06F 3/01

(52) U.S. Cl. CPC G06F 3/011

(57) ABSTRACT

Some techniques are for interrupting user activities in accordance with some embodiments. Other techniques are for summarizing user activities in accordance with some embodiments.

### CROSS-REFERENCE TO RELATED APPLICATIONS

This application claims priority to U.S. Provisional Patent Application Ser. No. 63/755,241, entitled “User Interfaces and Techniques for Managing User Activity” filed Feb. 6, 2025, and U.S. Provisional Patent Application Ser. No. 63/976,819, entitled “User Interfaces and Techniques for Managing User Activity” filed Feb. 5, 2026, which are hereby incorporated by reference in their entirety for all purposes.

### SUMMARY

Existing techniques for managing user activities are generally cumbersome and inefficient. For example, some existing techniques use a complex and time-consuming user interface, which may include multiple key presses or keystrokes. Some existing techniques require more time than necessary, wasting user time and device energy. This latter consideration is particularly important in battery-operated devices.

Accordingly, the present technique provides electronic devices with faster, more efficient processes and interfaces for managing user activities. Such processes and interfaces optionally complement or replace other processes for managing user activities. Such processes and interfaces reduce the cognitive burden on a user and produce a more efficient human-machine interface. For battery-operated computing devices, such processes and interfaces conserve power and increase the time between battery charges.

In some embodiments, a method that is performed at a computer system that is in communication with one or more input devices and one or more output devices is described. In some embodiments, the method comprises: detecting, via the one or more input devices, an activity of a subject; and in response to detecting the activity of the subject: in accordance with a determination that the activity satisfies a set of one or more criteria, outputting, via the one or more output devices, an indication to interrupt the activity; and in accordance with a determination that the activity does not satisfy the set of one or more criteria, forgoing output of, via the one or more output devices, the indication to interrupt the activity.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an activity of a subject; and in response to detecting the activity of the subject: in accordance with a determination that the activity satisfies a set of one or more criteria, outputting, via the one or more output devices, an indication to interrupt the activity; and in accordance with a determination that the activity does not satisfy the set of one or more criteria, forgoing output of, via the one or more output devices, the indication to interrupt the activity.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an activity of a subject; and in response to detecting the activity of the subject: in accordance with a determination that the activity satisfies a set of one or more criteria, outputting, via the one or more output devices, an indication to interrupt the activity; and in accordance with a determination that the activity does not satisfy the set of one or more criteria, forgoing output of, via the one or more output devices, the indication to interrupt the activity.

In some embodiments, a computer system configured to communicate with one or more input devices and one or more output devices is described. In some embodiments, the computer system comprises one or more processors and memory storing one or more programs configured to be executed by the one or more processors. In some embodiments, the one or more programs includes instructions for: detecting, via the one or more input devices, an activity of a subject; and in response to detecting the activity of the subject: in accordance with a determination that the activity satisfies a set of one or more criteria, outputting, via the one or more output devices, an indication to interrupt the activity; and in accordance with a determination that the activity does not satisfy the set of one or more criteria, forgoing output of, via the one or more output devices, the indication to interrupt the activity.

In some embodiments, a computer system configured to communicate with one or more input devices and one or more output devices is described. In some embodiments, the computer system comprises means for performing each of the following steps: detecting, via the one or more input devices, an activity of a subject; and in response to detecting the activity of the subject: in accordance with a determination that the activity satisfies a set of one or more criteria, outputting, via the one or more output devices, an indication to interrupt the activity; and in accordance with a determination that the activity does not satisfy the set of one or more criteria, forgoing output of, via the one or more output devices, the indication to interrupt the activity.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, an activity of a subject; and in response to detecting the activity of the subject: in accordance with a determination that the activity satisfies a set of one or more criteria, outputting, via the one or more output devices, an indication to interrupt the activity; and in accordance with a determination that the activity does not satisfy the set of one or more criteria, forgoing output of, via the one or more output devices, the indication to interrupt the activity.

In some embodiments, a method that is performed at a computer system that is in communication with one or more input devices and one or more output devices is described. In some embodiments, the method comprises: detecting, via the one or more input devices, an input corresponding to an instruction; after detecting the input corresponding to the instruction, detecting, via the one or more input devices, that a subject performed an activity; and after detecting that the subject performed the activity: in accordance with a determination that the activity corresponds to the instruction, outputting, via the one or more output devices, content corresponding to a summary of the activity performed; and in accordance with a determination that the activity does not correspond to the instruction, forgoing output of, via the one or more output devices, the content corresponding to the summary of the activity performed.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an input corresponding to an instruction; after detecting the input corresponding to the instruction, detecting, via the one or more input devices, that a subject performed an activity; and after detecting that the subject performed the activity: in accordance with a determination that the activity corresponds to the instruction, outputting, via the one or more output devices, content corresponding to a summary of the activity performed; and in accordance with a determination that the activity does not correspond to the instruction, forgoing output of, via the one or more output devices, the content corresponding to the summary of the activity performed.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an input corresponding to an instruction; after detecting the input corresponding to the instruction, detecting, via the one or more input devices, that a subject performed an activity; and after detecting that the subject performed the activity: in accordance with a determination that the activity corresponds to the instruction, outputting, via the one or more output devices, content corresponding to a summary of the activity performed; and in accordance with a determination that the activity does not correspond to the instruction, forgoing output of, via the one or more output devices, the content corresponding to the summary of the activity performed.

In some embodiments, a computer system configured to communicate with one or more input devices and one or more output devices is described. In some embodiments, the computer system comprises one or more processors and memory storing one or more programs configured to be executed by the one or more processors. In some embodiments, the one or more programs includes instructions for: detecting, via the one or more input devices, an input corresponding to an instruction; after detecting the input corresponding to the instruction, detecting, via the one or more input devices, that a subject performed an activity; and after detecting that the subject performed the activity: in accordance with a determination that the activity corresponds to the instruction, outputting, via the one or more output devices, content corresponding to a summary of the activity performed; and in accordance with a determination that the activity does not correspond to the instruction, forgoing output of, via the one or more output devices, the content corresponding to the summary of the activity performed.

In some embodiments, a computer system configured to communicate with one or more input devices and one or more output devices is described. In some embodiments, the computer system comprises means for performing each of the following steps: detecting, via the one or more input devices, an input corresponding to an instruction; after detecting the input corresponding to the instruction, detecting, via the one or more input devices, that a subject performed an activity; and after detecting that the subject performed the activity: in accordance with a determination that the activity corresponds to the instruction, outputting, via the one or more output devices, content corresponding to a summary of the activity performed; and in accordance with a determination that the activity does not correspond to the instruction, forgoing output of, via the one or more output devices, the content corresponding to the summary of the activity performed.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, an input corresponding to an instruction; after detecting the input corresponding to the instruction, detecting, via the one or more input devices, that a subject performed an activity; and after detecting that the subject performed the activity: in accordance with a determination that the activity corresponds to the instruction, outputting, via the one or more output devices, content corresponding to a summary of the activity performed; and in accordance with a determination that the activity does not correspond to the instruction, forgoing output of, via the one or more output devices, the content corresponding to the summary of the activity performed.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for authentication, thereby increasing the effectiveness, efficiency, and user satisfaction with such devices. Such methods and interfaces may complement or replace other methods for authentication.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a computer system in accordance with some embodiments.

FIGS. 1B-1G illustrate the use of Application Programming Interfaces (APIs) to perform operations.

FIGS. 2A-2C are diagrams illustrating exemplary components and user interfaces of an electronic device in accordance with some embodiments.

FIG. 3 is a block diagram illustrating exemplary components of a device in accordance with some embodiments.

FIG. 4 is a functional diagram of an exemplary actuator device in accordance with some embodiments.

FIG. 5 is a functional diagram of an exemplary agent system in accordance with some embodiments.

FIGS. 6A-6K illustrate exemplary user interfaces for managing user activities in accordance with some embodiments.

FIG. 7 is a flow diagram illustrating a process for interrupting user activities in accordance with some embodiments.

FIG. 8 is a flow diagram illustrating a process for summarizing user activities in accordance with some embodiments.

### DETAILED DESCRIPTION

The description to follow sets forth exemplary processes, components, parameters, and the like. While specific examples are set out below, it should be recognized that such embodiments should not be understood as limiting the scope of the present disclosure to the explicit descriptions of the examples set forth herein but instead should be understood as providing illustrative examples.

One or more steps of the processes described herein can rely on (e.g., be contingent on) one or more conditions being satisfied. In some embodiments, a process is performed by iterating a process multiple times. In some embodiments, contingent steps can be satisfied on different iterations of the same process and still be within the scope of the processes described herein. For example, for a given process that includes two steps that are contingent on different conditions, one of ordinary skill in the art would understand that the given process is considered performed even when a process is repeated multiple times until the contingent steps are satisfied. In some embodiments, multiple iterations of a process are not required to in order to practice claims as presented herein. For example, electronic device, system, or computer readable medium claims can be performed without iteratively repeating a process. In some embodiments, the electronic device, system, or computer readable medium claims include instructions for performing one or more steps that are contingent upon one or more conditions being satisfied. Because such instructions are stored in one or more processors and/or at one or more memory locations, the electronic device, system, or computer readable medium claims can include logic that determines whether the one or more conditions have been satisfied without needing to repeat steps of a process.

Although elements are described below using numerical descriptors, such as “a first” and/or “a second,” these elements do not correspond to order or distinct representations and should not be limited to the stated numerical term. In some embodiments, these terms simply used as prefix to distinguish a reference to one element from a reference to another element. For example, a “first” device and a “second” device can be two separate references to the same device. In contrast, for example, a “first” device and a “second” device can be a reference to two different devices (e.g., not the same device and/or not the same type of device). For example, a first computer system and a second computer system do not correspond to a first and a second in time, and merely are used to distinguish between two computer systems. As such, the first computer system can be termed a second computer system, and the second computer system can be termed a first computer system without departing from the scope of the various described embodiments.

For description of various elements and examples, the use of certain terminology is used to provide productive descriptions of the subject matter below and should not be read as limiting. As used to describe various examples herein, the singular forms of “a,” “an,” and “the” should not be interpreted as precluding or excluding the plural forms as well, unless the context clearly indicates otherwise. As well, “and/or” is used to encompasses any and all possible combinations of one or more associated listed items. For example, “x and/or y” should be interpreted as including “x,” or “y,” as well as “x and y” as possible permutations. Further, the use of the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

When describing choices and/or logical possibilities, the term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

The processes described below enhance the operability of the devices and make the user-device and/or user-device interfaces more efficient (e.g., by helping the user to provide proper inputs and reducing user mistakes when operating/interacting with the device) through various techniques, including by providing improved feedback (e.g., visual, haptic, acoustic, and/or tactile feedback) to the user, reducing the number of inputs needed to perform an operation, providing additional control options without cluttering the user interface with additional displayed controls, performing an operation when a set of conditions has been met without requiring further input (e.g., input by a user), and/or additional techniques, such as increasing the security and/or privacy of the computer system and reducing burn-in of one or more portions of a user interface of a display. These techniques also reduce power usage and improve battery life of the device by enabling the user to use the device more quickly and efficiently.

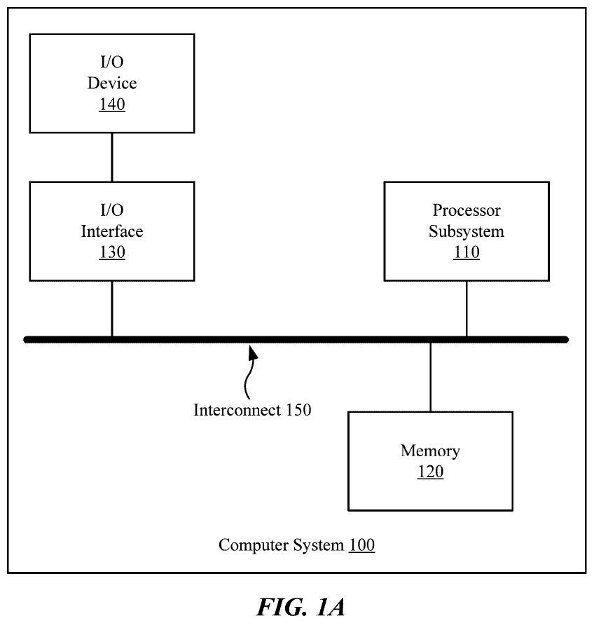

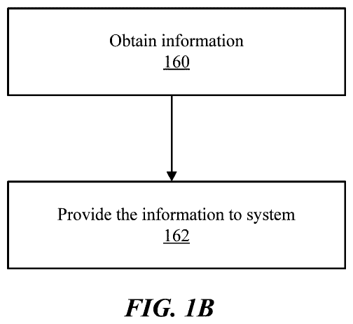

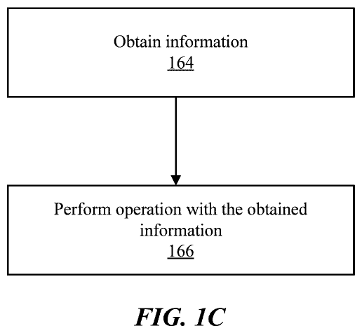

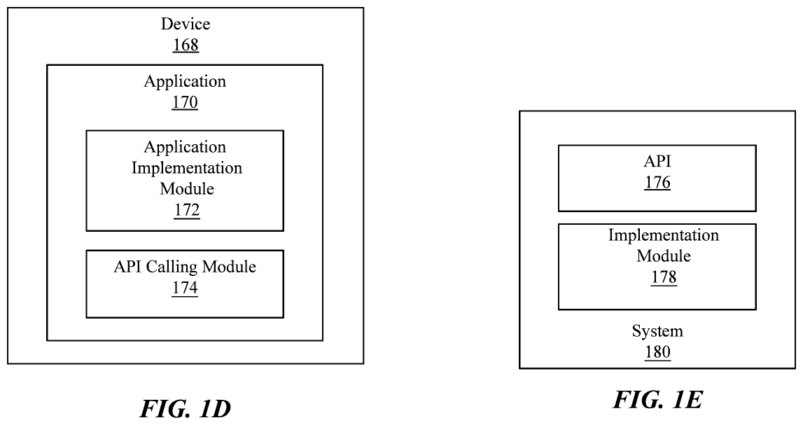

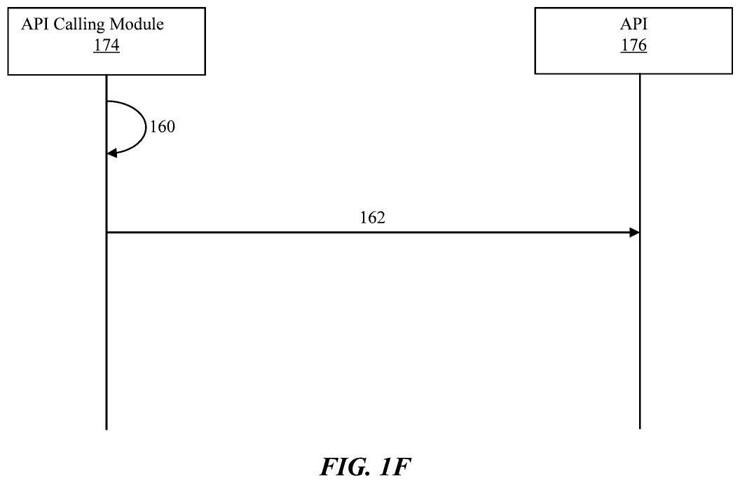

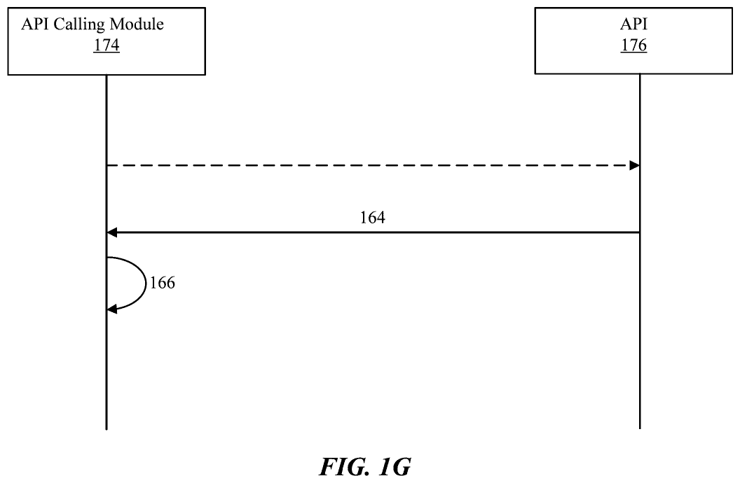

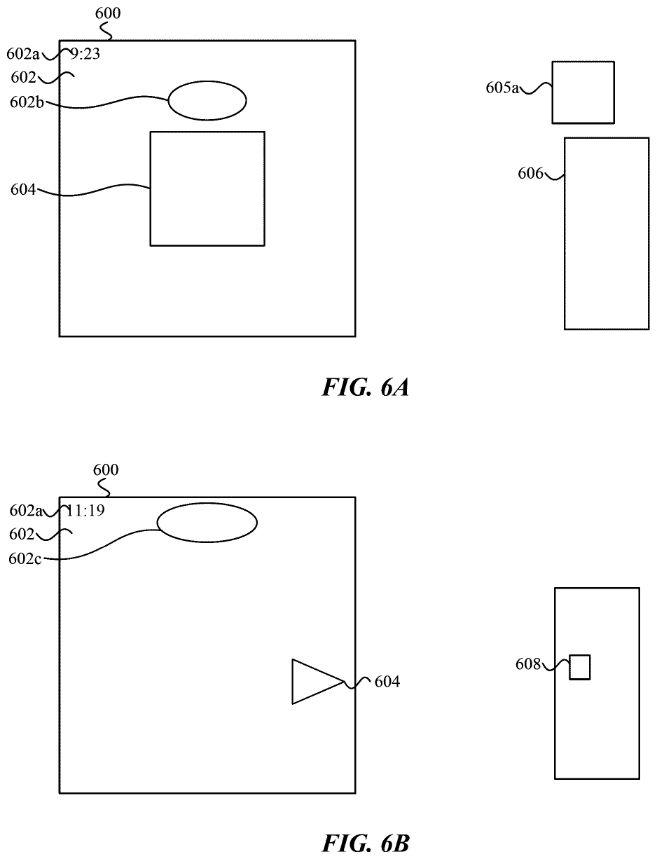

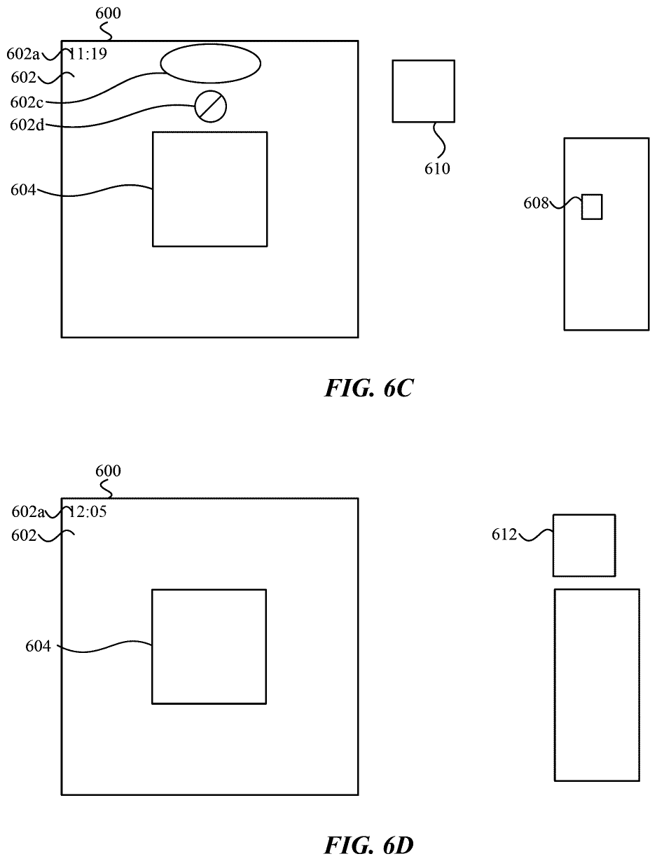

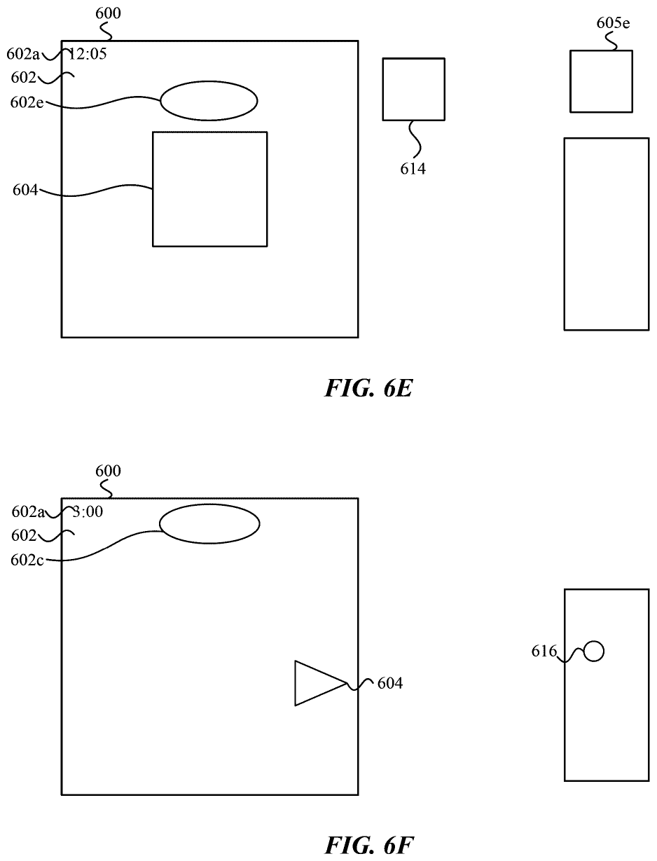

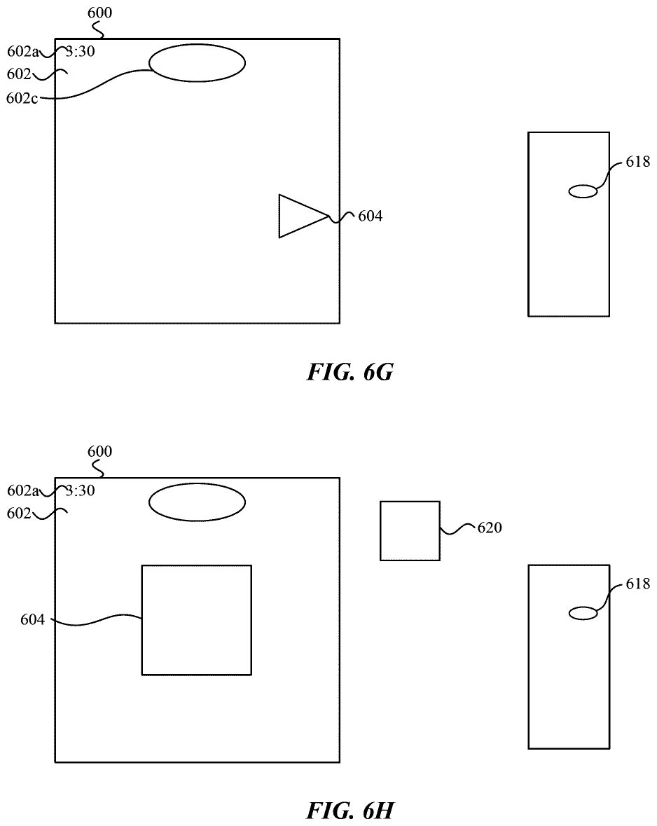

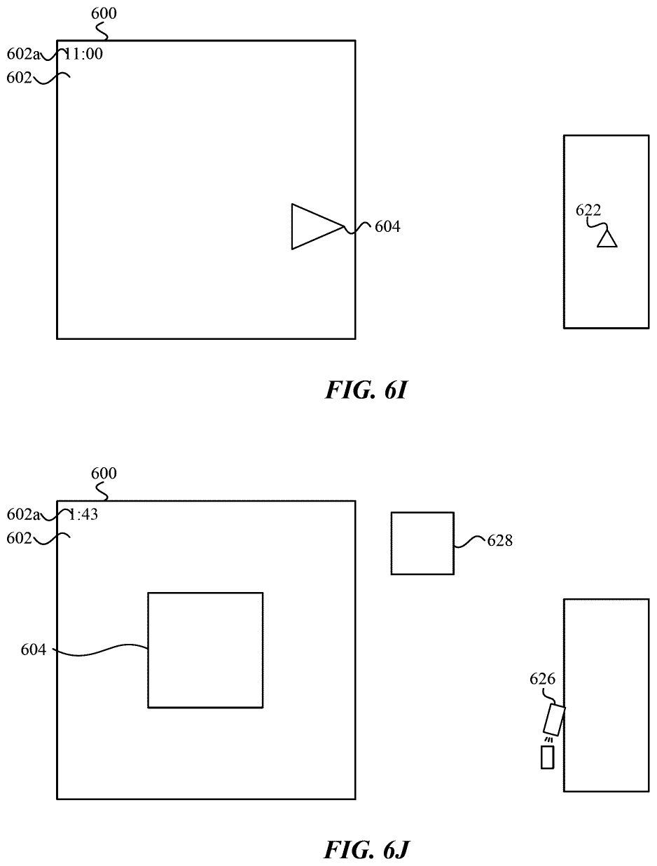

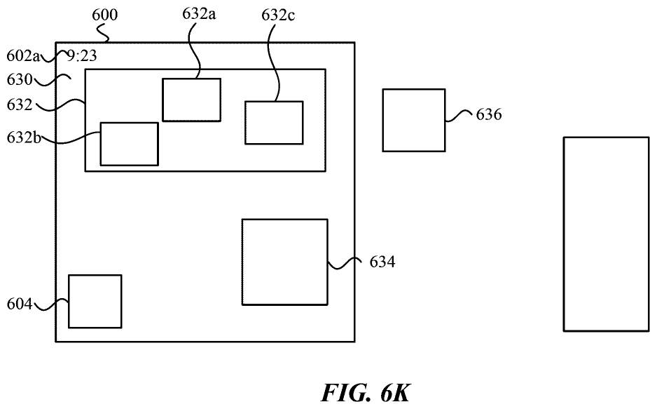

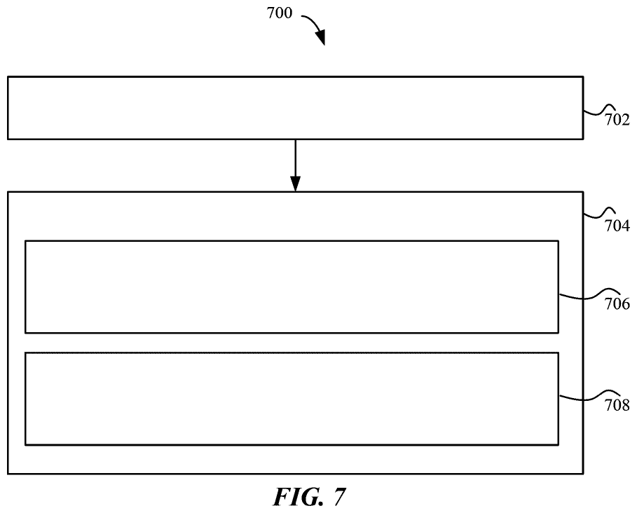

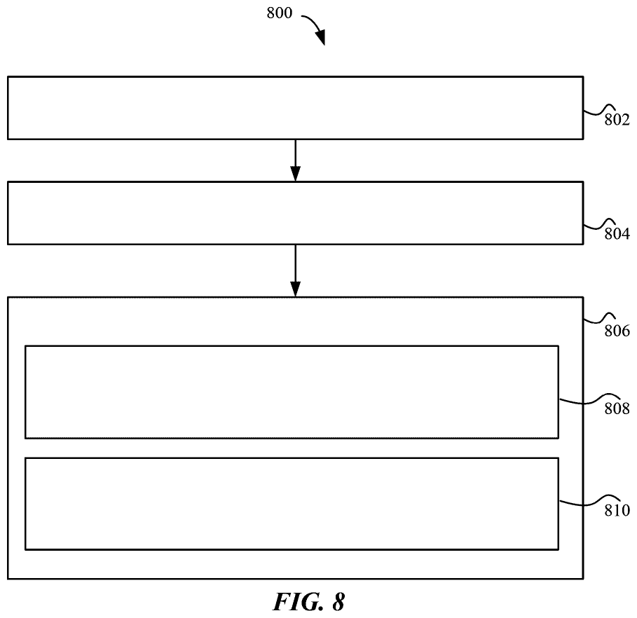

Below, FIGS. 1A-1G, 2A-2C, and 3-5 provide a description of exemplary devices for performing the techniques for managing user activities. FIGS. 6A-6K illustrate exemplary user interfaces for performing the techniques for managing user activities in accordance with some embodiments. FIG. 7 is a flow diagram illustrating a process for interrupting user activities in accordance with some embodiments. The user interfaces in FIGS. 6A-6K are used to illustrate the processes described below, including the processes in FIG. 7. FIG. 8 is a flow diagram illustrating a process for summarizing user activities in accordance with some embodiments. The user interfaces in FIGS. 6A-6K are used to illustrate the processes described below, including the processes in FIG. 8.

FIG. 1A depicts a block diagram of computer system 100 (e.g., electronic device and/or electronic system) including a set of electronic components in communication with (e.g., connected to) (e.g., wired or wirelessly) to each other. It should be understood that computer system 100 is merely one example of a computer system that can be used to perform functionality described below and that one or more other computer systems can be used to perform the functionality described below. Additionally, while FIG. 1A depicts a computer architecture of computer system 100, other computer architectures (e.g., including more components, similar components, and/or fewer components) of a computer system can be used to perform functionality described herein.

In some embodiments, computer system 100 can correspond to (e.g., be and/or include) a system on a chip, a server system, a personal computer system, a smart phone, a smart watch, a wearable device, a tablet, a laptop computer, a fitness tracking device, a head-mounted display (HMD) device, a desktop computer, a communal device (e.g., smart speaker, connected thermostat, and/or additional home based computer systems), an accessory (e.g., switch, light, speaker, air conditioner, heater, window cover, fan, lock, media playback device, and/or television), a controller, a hub, and/or a sensor.

In some embodiments, a sensor includes one or more hardware components capable of detecting (e.g., sensing, generating, and/or processing) information about a physical environment in proximity to the sensor. For example, a sensor can be configured to detect information surrounding the sensor, detect information in one or more directions casting away from the sensor, and/or detect information based on contact of the sensor with an element of the physical environment. In some embodiments, a hardware component of a sensor includes a sensing component (e.g., a temperature and/or image sensor), a transmitting component (e.g., a radio and/or laser transmitter), and/or a receiving component (e.g., a laser and/or radio receiver). In some embodiments, a sensor includes an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a microphone, a motion sensor, a range or depth sensor (e.g., RADAR and/or LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. While only a single computer system is depicted in FIG. 1A, functionality described below can be implemented with two or more computer systems operating together. Additionally, in some embodiments, computer system 100 includes one or more sensors as described above, and information about the physical environment is captured by combining data from one sensor with data from one or more additional sensors (e.g., that are part of the computer and/or one or more additional computer systems).

As illustrated in FIG. 1A, computer system 100 consists of processor subsystem 110, memory 120, and I/O interface 130. Memory 120 corresponds to system memory in communication with processor subsystem 110. The electronic components making up computer system 100 are electrically connected through interconnect 150, which allows communication between the components of computer system 100. For example, interconnect 150 can be a system bus, one or more memory locations, and/or additional electrical channels for connective multiple components of computer system 100. Also, I/O interface 130 is connected to, via a wired and/or wireless connection, I/O device 140. In some embodiments, computer system 100 includes a component made up of I/O interface 130 and I/O device 140 such that the functionality of the individual components is included in the component. Additionally, it should be understood that computer system 100 can include one or more I/O interfaces, communicating with one or more I/O devices. In some embodiments, computer system 100 consists of multiple processor subsystems (e.g., processor subsystem 110), each electrically connected through interconnect 150.

In some embodiments, processor subsystem 110 includes one or more processors or individual processing units capable of executing instructions (e.g., program, system, and/or interrupt) to perform functionality described herein. For example, operating system level and/or application level instructions executed by processor subsystem 110. In some embodiments, processor subsystem 110 includes one or more components (e.g., implemented as hardware, software, and/or a combination thereof) capable of supporting, interpreting, and/or performing machine learning instructions and/or operations. For example, computer system 100 can perform operations according to a machine learning model locally. Alternatively, or in addition, computer system 100 can communicate with (e.g., performing calculations on and/or executing instructions corresponding to) a remote interactive knowledge base (e.g., a processing resource that implements a machine learning model, artificial intelligence model, and/or large language model) to perform operations that can be otherwise outside a set of capabilities of computer system 100. For example, computer system 100 can determine a set of inputs (e.g., instructions, data, and/or parameters) to the interactive knowledge base for performing desired machine learning operations.

Memory 120 in communication with processor subsystem 110 can be implemented by a variety of different physical, non-transitory memory media. In some embodiments, computer system 100 includes multiple memory components and/or multiple types of memory components, each connected to processor subsystem 110 directly and/or via interconnect 150. For example, memory 120 can be implemented using a removable flash drive, storage array, a storage area network (e.g., SAN), flash memory, hard disk storage, optical drive storage, floppy disk storage, removable disk storage, random access memory (e.g., SDRAM, DDR SDRAM, RAM-SRAM, EDO RAM, and/or RAMBUS RAM), and/or read only memory (e.g., PROM and/or EEPROM). Additionally, in some embodiments, processor subsystem 110 and/or interconnect 150 is connected to a memory controller that is electrically connected to memory 120.

In some embodiments, instructions can be executed by processor subsystem 110. In this example, memory 120 can include a computer readable medium (e.g., non-transitory or transitory computer readable medium) usable to store (e.g., configured to store, assigned to store, and/or that stores) instructions to be executable by processor subsystem 110. In some embodiments, each instruction stored by memory 120 and executed by processor subsystem 110 corresponds to an operation for completing the functionality described herein. For example, memory 120 can store program instructions to implement the functionality associated with managing user activities described below.

As mentioned above, I/O interface 130 can be one or more types of interfaces enabling computer system 100 to communicate with other devices. In some embodiments, I/O interface 130 includes a bridge chip (e.g., Southbridge) from a front-side bus to one or more back-side buses. In some embodiments, I/O interface 130 enables communication with one or more I/O devices, illustrated as I/O device 140, via one or more corresponding buses or other interfaces. For example, an I/O device can include one or more: physical user-interface devices (e.g., a physical keyboard, a mouse, and/or a joystick), storage devices (e.g., as described above with respect to memory 120), network interface devices (e.g., to a local or wide-area network), sensor devices (e.g., as described above with respect to sensors), and/or auditory and/or visual output devices (e.g., screen, speaker, light, and/or projector). In some embodiments, the visual output device is referred to as a display component. For example, the display component can be configured to provide visual output, such as displaying images on a physically viewable medium via an LED display or image projection. As used herein, “displaying” content includes causing to display the content (e.g., video data rendered and/or decoded by a display controller) by transmitting, via a wired or wireless connection, data (e.g., image data and/or video data) to an integrated or external display component to visually produce the content.

In some embodiments, computer system 100 includes a component that integrates I/O device 140 with other components (e.g., a component that includes I/O interface 130 and I/O device 140). In some embodiments, I/O device 140 is separate from other components of computer system 100 (e.g., is a discrete component). In some embodiments, I/O device 140 includes a network interface device that permits computer system 100 to connect to (e.g., communicate with) a network or other computer systems, in a wired or wireless manner. In some embodiments, a network interface device can include Wi-Fi, Bluetooth, NFC, USB, Thunderbolt, Ethernet, and so forth. For example, computer system 100 can utilize an NFC connection to facilitate a bank, credit, financial, token (e.g., fungible or non-fungible token), and/or cryptocurrency transaction between computer system 100 and another computer system within proximity.

In some embodiments, I/O device 140 includes components for detecting a user (e.g., a user, a person, an animal, another computer system different from the computer system, and/or an object) and/or an input (e.g., a tap input and/or a non-tap input (e.g., a verbal input, an acoustic request, an acoustic command, an acoustic statement, a swipe input, a hold-and-drag input, a gaze input, an air gesture, and/or a mouse click)) from a detected user. In some embodiments, I/O device 140 enables computer system 100 to identify users associated with and/or without an account within an environment. For example, computer system 100 can detect a known user (e.g., a user that corresponds to an account) and access information about the user using the known user's account. In some embodiments, as part of computer system 100 detecting a user, computer system 100 detects that the user's account is associated with (e.g., is included in and/or identified with respect to) a group of users. For example, computer system 100 can access information associated with a family of accounts in response to detecting a member of the family that is defined as a group of accounts. In some embodiments, an account corresponding to a user can be connected with additional accounts and/or additional computer systems. For example, computer system 100 can detect such additional computer systems and/or detect such computer systems for detecting the user. In some embodiments, computer system 100 detects unknown users and enables guest accounts for the unknown users to utilize computer system 100.

In some embodiments, I/O device 140 includes one or more cameras. In some embodiments, a camera includes an image sensor (e.g., one or more optical sensors and/or one or more depth camera sensors) that provides computer system 100 with the ability to detect a user and/or a user's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, the one or more cameras enable computer system 100 to transmit pictorial and/or video information to an application. For example, image data captured by a camera can enable computer system 100 to complete a video phone call by transmitting video data to an application for performing the video phone call.

In some embodiments, I/O device 140 includes one or more microphones. For example, a microphone can be used by 100 to obtain data and/or information from a user without a contact input. In some embodiments, a microphone enables computer system 100 to detect verbal and/or speech input from a user. In some embodiments, computer system 100 utilizes speech input to enable personal assistant functionality. For example, a user eliciting a request to computer system 100 to perform an action and/or obtain information for the user. In some embodiments, computer system 100 utilizes speech input (e.g., along with one or more other input and/or output techniques) to request and/or detect information from a user without requiring the user to make physical contact with computer system 100.

In some embodiments, I/O device 140 includes physical input mediums for a user to interact directly with computer system 100. In some embodiments, a physical input medium includes one or more physical buttons (e.g., tactile depressible button and/or touch sensitive non-depressible component) on computer system 100 and/or connected to computer system 100, a mouse and keyboard input method (e.g., connected to computer system 100 together and/or separately with one or more I/O interfaces), and/or a touch sensitive display component.

In some embodiments, I/O device 140 includes one or more components for outputting information (e.g., a display component, an audio generation component, a speaker, a haptic output device, a display screen, a projector, and/or a touch-sensitive display). In some embodiments, computer system 100 uses I/O device 140 to convey information and/or a state of computer system 100. In some embodiments, I/O device 140 includes a tactile output device. For example, a tactile output device can be a haptic component that enables computer system 100 to convey information to a user in contact with (e.g., holding, touching, and/or nearby) computer system 100. In some embodiments, I/O device 140 includes one or more components for outputting visual outputs (e.g., video, image, animation, 3D rendering, augmented reality overlay, motion graphics, data visualization, and/or digital art). For example, displaying content from one or more applications and/or system applications, and/or displaying a widget (e.g., a control that displays real-time information and/or data) corresponding to one or more applications.

In some embodiments, I/O device 140 includes one or more components for outputting audio (e.g., smart speakers, home theater system, soundbars, headphones, earphones, earbuds, speakers, television speakers, augmented reality headset speakers, audio jacks, optical audio output, Bluetooth audio outputs, HDMI audio outputs, and/or audio sensors). In some embodiments, computer system 100 is able to output audio through the one or more speakers. For example, computer system 100 outputting audio-based content and/or information to a user. In some embodiments, the one or more speakers enable spatial audio (e.g., an audio output corresponding to an environment (e.g., computer system 100 detecting materials and/or objects within the environment and/or computer system 100 altering the audio pattern, intensity, and/or waveform to compensate for varying characteristics of an environment)).

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or methods described herein.

It should be recognized that application 170 can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 170 is an application that is pre-installed on device 168 at purchase (e.g., a first-party application). In some embodiments, application 170 is an application that is provided to device 168 via an operating system update file (e.g., a first-party application or a second-party application). In some embodiments, application 170 is an application that is provided via an application store. In some embodiments, the application store can be an application store that is pre-installed on device 168 at purchase (e.g., a first-party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to a system (e.g., 162).

In some embodiments, the system (e.g., 180 shown in FIG. 1E) is an operating system hosted on device 168. In some embodiments, the system (e.g., 180 shown in FIG. 1E) is an external device (e.g., a server, a peripheral device, an accessory, and/or a personal computing device) that includes an operating system.

Referring to FIG. 1C and FIG. 1G, application 170 obtains information (e.g., 164). In some embodiments, the information obtained at 164 includes positional information, time information, notification information, user information, environment information, electronic device state information, weather information, media information, historical information, event information, hardware information, and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. As illustrated in FIG. 1D, device 168 includes application 170 and an operating system (e.g., system 180 shown in FIG. 1E). Application 170 includes application implementation module 172 and API calling module 174. System 180 includes API 176 and implementation module 178. It should be recognized that device 168, application 170, and/or system 180 can include more, fewer, and/or different components than illustrated in FIGS. 1D and 1E.

In some embodiments, application implementation module 172 includes a set of one or more instructions corresponding to one or more operations performed by application 170. For example, when application 170 is a messaging application, application implementation module 172 can include operations to receive and send messages. In some embodiments, application implementation module 172 communicates with API calling module 174 to communicate with system 180 via API 176 (shown in FIG. 1E).

In some embodiments, API 176 is a software module (e.g., a collection of computer-readable instructions) that provides an interface that allows a different module (e.g., API calling module 174) to access and/or use one or more functions, methods, procedures, data structures, classes, and/or other services provided by implementation module 178 of system 180. For example, API calling module 174 can access a feature of implementation module 178 through one or more API calls or invocations (e.g., embodied by a function or a method call) exposed by API 176 (e.g., a software and/or hardware module that can receive API calls, respond to API calls, and/or send API calls) and can pass data and/or control information using one or more parameters via the API calls or invocations. In some embodiments, API 176 allows application 170 to use a service provided by a Software Development Kit (SDK) library. In some embodiments, application 170 incorporates a call to a function or method provided by the SDK library and provided by API 176 or uses data types or objects defined in the SDK library and provided by API 176. In some embodiments, API calling module 174 makes an API call via API 176 to access and use a feature of implementation module 178 that is specified by API 176. In such embodiments, implementation module 178 can return a value via API 176 to API calling module 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low-level logic that executes in part on the hardware component.

In some embodiments, API 176 allows a developer of API calling module 174 (which can be a third-party developer) to leverage a feature provided by implementation module 178. In such embodiments, there can be one or more API-calling modules (e.g., including API calling module 174) that communicate with implementation module 178. In some embodiments, API 176 allows multiple API-calling modules written in different programming languages to communicate with implementation module 178 (e.g., API 176 can include features for translating calls and returns between implementation module 178 and API calling module 174) while API 176 is implemented in terms of a specific programming language. In some embodiments, API calling module 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing a secure connection (e.g., with an accessory)), a device detection API (e.g., for locating nearby devices (e.g., media devices and/or smartphone)), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API. In some embodiments, the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, LiDAR data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 178 is a system (e.g., operating system, and/or server system) software module (e.g., a collection of computer-readable instructions) that is constructed to perform an operation in response to receiving an API call via API 176. In some embodiments, implementation module 178 is constructed to provide an API response (via API 176) as a result of processing an API call. By way of example, implementation module 178 and API calling module 174 can each be any one of an operating system, a library, a device driver, an API, an application program, or other module. It should be understood that implementation module 178 and API calling module 174 can be the same or different type of module from each other. In some embodiments, implementation module 178 is embodied at least in part in firmware, microcode, or hardware logic.

In some embodiments, implementation module 178 returns a value through API 176 in response to an API call from API calling module 174. While API 176 defines the syntax and result of an API call (e.g., how to invoke the API call and what the API call does), API 176 might not reveal how implementation module 178 accomplishes the function specified by the API call. Various API calls are transferred via the one or more application programming interfaces between API calling module 174 and implementation module 178. Transferring the API calls can include issuing, initiating, invoking, calling, receiving, returning, and/or responding to the function calls or messages. In other words, transferring can describe actions by either of API calling module 174 or implementation module 178. In some embodiments, a function call or other invocation of API 176 sends and/or receives one or more parameters through a parameter list or other structure.

In some embodiments, implementation module 178 provides more than one API, each providing a different view of or with different aspects of functionality implemented by implementation module 178. For example, one API of implementation module 178 can provide a first set of functions and can be exposed to third-party developers, and another API of implementation module 178 can be hidden (e.g., not exposed) and provide a subset of the first set of functions and also provide another set of functions, such as testing or debugging functions which are not in the first set of functions. In some embodiments, implementation module 178 calls one or more other components via an underlying API and thus is both an API calling module and an implementation module. It should be recognized that implementation module 178 can include additional functions, methods, classes, data structures, and/or other features that are not specified through API 176 and are not available to API calling module 174. It should also be recognized that API calling module 174 can be on the same system as implementation module 178 or can be located remotely and access implementation module 178 using API 176 over a network. In some embodiments, implementation module 178, API 176, and/or API calling module 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform the functions of managing user activities by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, API 176 defines a first API call that can be provided by AP I-calling module 1180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 168) that runs the application. In some embodiments, the implementation module is included in an electronic device that is separate from the device that runs the application.

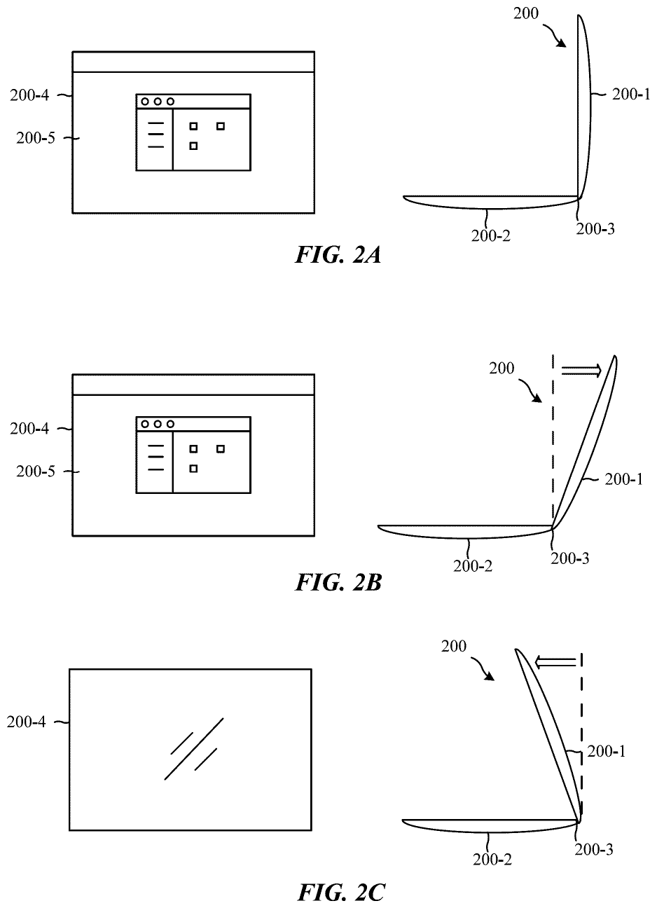

FIGS. 2-5 illustrate exemplary components and user interfaces of device 200 in accordance with some embodiments. Device 200 (sometimes referred to herein as device 200) can include one or more features of computer system 100. In the examples described with respect to FIGS. 2-5, device 200 is a laptop computer. In some embodiments, device 200 is not limited to being a laptop computer and one of ordinary skill in the art should recognize that device 200 can be one or more other devices (e.g., as described herein and/or that include one or more of the components and/or functions described herein with respect to device 200). For example, device 200 can be a communal device (such as a smart display, a smart speaker, and/or a television) and/or a personal device (such as a smart phone, a smart watch, a tablet, a desktop computer, a fitness tracking device, and/or a head mounted display device). In some embodiments, a communal device is configured to provide functionality to multiple users (e.g., at the same time and/or at different times). In such embodiments, the communal device can be administered and/or set up by a single user. In some embodiments, a personal device is configured to provide functionality to a single user (e.g., at a time, such as when the single user is logged into the personal device).

FIGS. 2A-2C illustrate device 200 in three different physical positions. As illustrated in FIG. 2A, device 200 is a laptop computer (also referred to herein as a “laptop”) that includes base portion 200-2 (e.g., that rests on a surface, such as a desk, horizontally as shown in FIG. 2A) and display portion 200-1 that is connected to base portion 200-2 at connection 200-3 (e.g., one or more connection points, a motorized arm, a hinge, and/or a joint) that enables display portion 200-1 to pivot and/or change orientation with respect to base portion 200-2. For example, device 200 can pivot at connection 200-3 to rotate display portion 200-1 and/or device 200 to one or more positions corresponding to an “OFF” internal state (e.g., as further described below in relation to FIG. 2C). In some embodiments, a position corresponding to an “OFF” internal state is a position in which device 200 is in a predetermined pose. For example, a predetermined pose can include display portion 200-1 positioned parallel to base portion 200-2 or display portion 200-1 forming a predetermined angle (e.g., 60-degree angle) with respect to base portion 200-2. In some embodiments, in the “OFF” internal state, an area in which content is displayed by device 200 is positioned in a manner that corresponds to (e.g., represents, is associated with, and/or is configured to accompany) the “OFF” internal state (e.g., facing down, not visible, and/or obscuring the area in which content is displayed). In some embodiments, in the “OFF” internal state, an area in which content is displayed by device 200 is not positioned in a manner that corresponds to (e.g., represents, is associated with, and/or is configured to accompany) the “OFF” internal state (e.g., instead is positioned in a manner that corresponds to an “ON” internal state). For example, when not in the “OFF” internal state, device 200 can be positioned within a range of different open positions (e.g., in which display portion 200-1 is not parallel to base portion 200-2 and the area in which content is displayed by device 200 is visible and/or not obscured). It should be recognized that display portion 200-1 being parallel to base portion 200-2 is an example of a position corresponding to an “OFF” internal state (e.g., a closed position) of device 200. In some embodiments, another configuration could set another orientation of display portion 200-1 with respect to base portion 200-2 as the closed position of device 200, such as illustrated in FIG. 2C.

FIG. 2A illustrates display screen 200-4 (representing the area in which content is displayed by device 200) on the left and device 200 in a corresponding pose on the right. As illustrated in FIG. 2A, device 200 is in a first position (e.g., display portion 200-1 is perpendicular to base portion 200-2 forming a 90-degree angle). In FIG. 2A, display screen 200-4 represents what is currently being displayed (e.g., via a display component) by device 200 while open in the first position. In FIG. 2A, display screen 200-4 illustrates an internal state in which device 200 is “ON” (e.g., operational, powered on, awake, a higher powered and/or more resource intensive state than the “OFF” state, and/or activated). In some embodiments, device 200 displays (e.g., via display screen 200-4) one or more user interfaces (e.g., user interface objects, windows, application user interfaces, system user interfaces, controls, and/or other visual content). In some embodiments, device 200 displays (e.g., via display screen 200-4) the one or more user interfaces while in the “ON” internal state. For example, in FIG. 2A, device 200 is in the “ON” internal state and display screen 200-4 displays a desktop user interface 200-5 that includes an application window. In some embodiments, a user interface includes (and/or is) one or more user interface objects (e.g., windows, icons, and/or other graphical objects). For example, a user interface (e.g., 200-5) can include one or more graphical objects different than, and/or the same as, an application window.

FIG. 2B illustrates display screen 200-4 on the left and device 200 in a corresponding pose on the right. As illustrated in FIG. 2B, device 200 is in a second position (e.g., display portion 200-1 is angled (e.g., via connection 200-3) with respect to base portion 200-2 forming at a 120-degree angle (e.g., a larger angle than in FIG. 2A)). In FIG. 2B, display screen 200-4 represents what is being displayed by device 200 while in the second position. Display screen 200-4 illustrates an internal state in which device 200 is “ON” (e.g., the same internal state as the top diagram of FIG. 2A). In FIG. 2B, device 200 displays (e.g., via display screen 200-4) desktop user interface 200-5 (e.g., and is the same as displayed in FIG. 2A). In some embodiments, device 200 displays a different user interface (e.g., other than desktop user interface 200-5). For example, although FIG. 2B illustrates device 200 displaying the same desktop user interface 200-5 as in FIG. 2A while in a different position than in FIG. 2A, device 200 can display a different user interface. In some embodiments, device 200 displays a user interface that corresponds to (e.g., is based on, due to, caused by, related to, and/or configured to accompany) a physical state (e.g., position, location, and/or orientation), including content that is specific to a particular angle or specific to a current context.

FIG. 2C illustrates display screen 200-4 on the left and device 200 in a corresponding pose on the right. As illustrated in FIG. 2C, device 200 is in a third position (e.g., display portion 200-1 is angled (e.g., via connection 200-3) with respect to base portion 200-2 forming at a 60-degree angle (e.g., a smaller angle than in FIG. 2A and FIG. 2B)). In FIG. 2C, display screen 200-4 represents what is being displayed by device 200 while in the third position. In FIG. 2C, display screen 200-4 illustrates an internal state in which device 200 is “OFF” (e.g., not operational, not powered on, not awake, not activated, powered off, asleep, hibernating, inactive, and/or deactivated). In some embodiments, device 200 does not display (e.g., via display screen 200-4) (e.g., forgoes displaying) the one or more user interfaces while in the “OFF” internal state (e.g., does not display any visual content). In some embodiments, device 200 displays (e.g., via display screen 200-4) one or more user interfaces while in the “OFF” internal state (e.g., the same and/or different from one or more user interfaces displayed while in the “ON” internal state) (e.g., a user interface specific to the “OFF” state and/or a manner of displaying a user interface that is not specific to the “OFF” internal state). In FIG. 2C, display screen 200-4 is blank because nothing is being displayed on the display of device 200 (e.g., display screen 200-4 is off and/or not displaying a user interface) (e.g., desktop user interface 200-5 is not displayed on display screen 200-4).

In some embodiments, device 200 includes one or more components (also referred to herein as “movement components”) that enable device 200 to perform (e.g., cause and/or control) movement (and/or be moved). For example, performing movement can include moving a portion of device 200 (e.g., less than or all components of the device move), moving all of device 200 (e.g., the entire device (including all of its components) moves, such as by changing location), and/or moving one or more other devices and/or components (e.g., that are in communication with device 200 and/or movement components of device 200). For example, device 200 can automatically move (e.g., pivot), cause, and/or control movement of display portion 200-1 relative to base portion 200-2, such as to any of the positions illustrated in FIGS. 2A-2C. In some embodiments, device 200 performs movement based on an internal state of device 200. Performing movement based on an internal state can enable new (e.g., otherwise unavailable) interactions by device 200. For example, such new interactions of device 200 can be configured using special features, functions, modes, and/or programs that take advantage of the ability of device 200 to perform movement. Examples of such interaction include using movement to communicate (e.g., to a user) an internal state (e.g., on, off, sleeping, and/or hibernating) of the device, to assist with user input (e.g., reduce distance to a user), and/or to augment interaction behavior of the device (e.g., moving in particular ways, during an interaction with a user, that convey information such as importance and/or direction of attention). In some embodiments, the movement performed corresponds to (e.g., is caused by, is in response to, and/or is determined and/or performed based on) one or more of: detected input, detected context (e.g., environmental context and/or user context), and/or an internal state of device 200 (e.g., an internal state and/or a set of multiple internal states). For example, device 200 can perform a movement of the display portion such that device 200 moves from being in the first position illustrated in FIG. 2A to being in the second position illustrated in FIG. 2B. In this example, device 200 can detect that a user has repositioned with respect to device 200 (e.g., the user stood up), and in response, device 200 can perform the movement to the second position so that the display is at an optimized viewing angle based on the repositioned height and/or angle of the user's eyes with respect to the display of device 200. As another example, device 200 can perform a movement such that device 200 moves from being in the first position illustrated in FIG. 2A to being in the third position illustrated in FIG. 2C. In this example, device 200 can perform the movement to the third position in response to detecting an internal state with reduced activity (e.g., the “OFF” internal state as described above). In this way, the movement of device 200 to one or more positions can indicate an internal state of device 200.

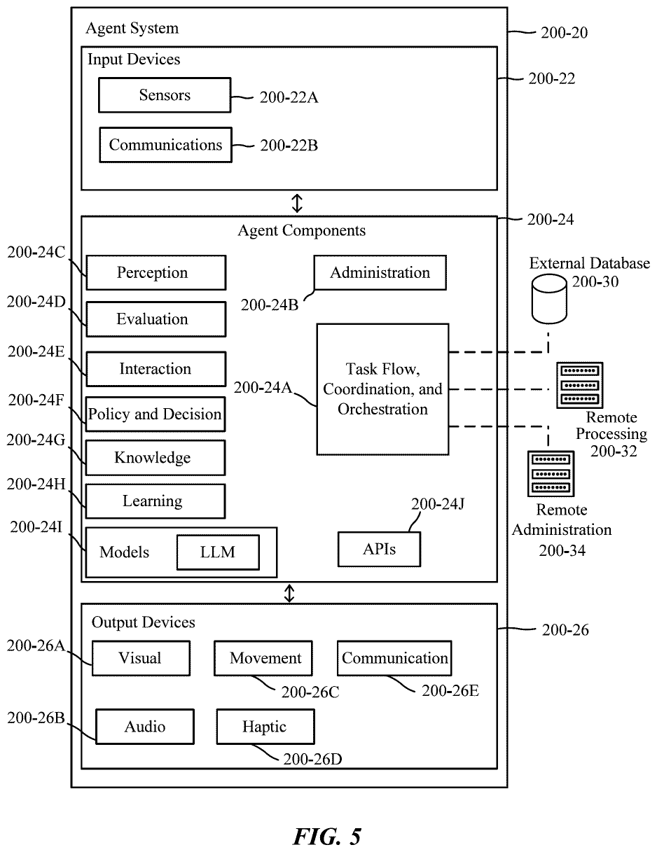

FIGS. 2A-2C illustrate device 200 having a display portion that is able to move with one degree of freedom via connection 200-3 (e.g., a hinge) connecting display portion 200-1 to base portion 200-2. In some embodiments, device 200 includes one or more components that have one or more degrees of freedom. For example, a movement component (e.g., an output device that causes and/or allows movement) (e.g., 200-26C of FIG. 5) of device 200 can include multiple degrees of freedom (e.g., six degrees of freedom including three components of translation and three components of rotation). For example, device 200 can be implemented to be able to move the display portion in a telescoping forward or backward motion (e.g., display portion 200-1 moves forward while base portion 200-2 remains stationary in space relative to the base portion (e.g., to reduce and/or extend viewing distance for a user)). As yet another example, device 200 can be implemented to be able to move the display portion to rotate about an axis that is perpendicular to the hinge such that the display portion can turn to position the display to follow a user as they walk around device 200. While the examples shown in FIGS. 2A-2C illustrate a hinge, other movement components can be included in device 200, such as an actuator (e.g., a pneumatic actuator, hydraulic actuator and/or an electric actuator), a movable base, a rotatable component, and/or a rotatable base. In some embodiments, one or more movement components can cause device 200 to move in different ways, such as to rotate (e.g., 0 -360 degrees), to move laterally (e.g., right, left, down, up, and/or any combination thereof), and/or to tilt (e.g., 0 -360 degrees).

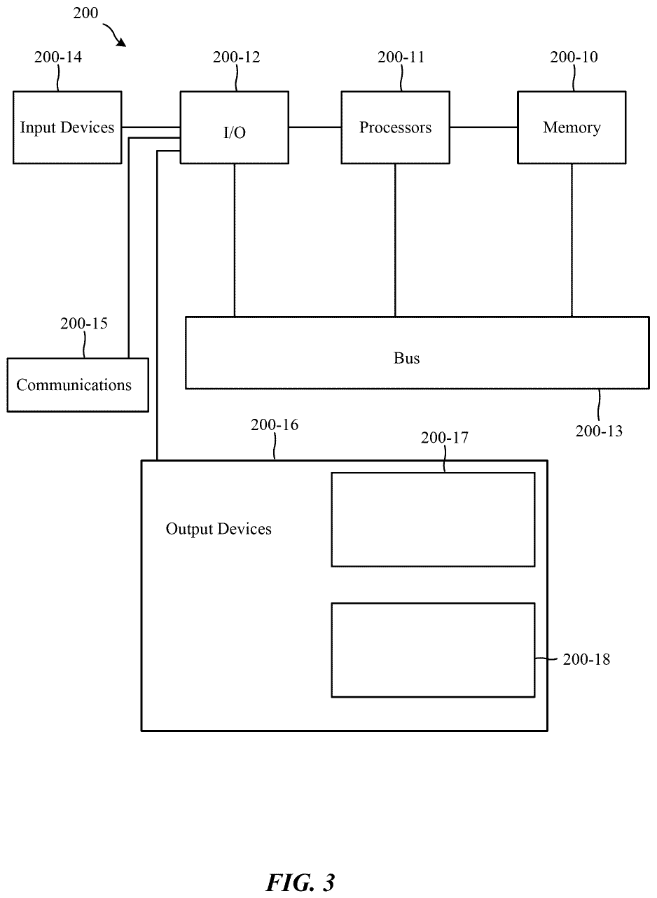

FIG. 3 illustrates exemplary block diagram of device 200. In some embodiments, device 200 includes some or all of the components described with respect to FIGS. 1A-1G, 3, and 5B. As illustrated in FIG. 3, device 200 has bus 200-13 that operatively couples I/O section 200-12 (also referred to as an I/O subsection and/or an I/O interface) with processors 200-11 and memory 200-10. As illustrated in FIG. 3, I/O section 200-12 is connected to output devices 200-16 (also referred to herein as “output devices”). In some embodiments, output devices 200-16 include one or more visual output devices (e.g., a display component, such as a display, a display screen, a projector, and/or a touch-sensitive display), one or more haptic output devices (e.g., a device that causes vibration and/or other tactile output), one or more audio output devices (e.g., a speaker), and/or one or more movement components (e.g., an actuator, a motor, a mechanical linkage, devices that cause and/or allow movement, and/or one or more movement components as described above). As illustrated in FIG. 3, output devices 200-16 include two exemplary movement components (e.g., movement controller 200-17 and actuator 200-18). Actuator 200-18 can be any component that performs physical movement (e.g., of a portion and/or of the entirety) of a device (e.g., device 200 and/or a device coupled to and/or in contact with device 200). Movement controller 200-17 can be any component (e.g., a control device) that controls (e.g., provides control signals to) actuator 200-18. For example, movement controller 200-17 can provide control signals that cause actuator 200-18 to actuate (e.g., cause physical movement). In some embodiments, movement controller 200-17 includes one or more logic component (e.g., a processor), one or more feedback component (e.g., sensor), and/or one or more control components (e.g., for applying control signals, such as a relay, a switch, and/or a control line). In some embodiments, movement controller 200-17 and actuator 200-18 are embodied in the same device and/or component as each other (e.g., a dedicated onboard movement controller 200-17 that is affixed to actuator 200-18). In some embodiments, movement controller 200-17 and actuator 200-18 are embodied in different devices and/or components from each other (e.g., one or more processors 200-11 can function as the movement controller 200-17 of actuator 200-18). In some embodiments, movement controller 200-17 and/or actuator 200-18 are embodied in a device (or one or more devices) other than device 200 (e.g., device 200 is coupled to (e.g., temporarily and/or removably) another device and can instruct movement controller 200-17 and/or control actuator 200-18 of the other device). Actuator 200-18 can function to cause one or more types of mechanical movement (e.g., linear and/or rotational) in one or more manners (e.g., using electric, magnetic, hydraulic, and/or pneumatic power). Examples of actuator 200-18 can include electromechanical actuators, linear actuators, and/or rotary actuators.

As illustrated in FIG. 3, I/O section 200-12 is connected to input devices 200-14. In some embodiments, input devices 200-14 include one or more visual input devices (e.g., a camera and/or a light sensor), one or more physical input devices (e.g., a button, a slider, a switch, a touch-sensitive surface, and/or a rotatable input mechanism), one or more audio input devices (e.g., a microphone), and/or other input devices (e.g., accelerometer, a pressure sensor (e.g., contact intensity sensor), a ranging sensor, a temperature sensor, a GPS sensor, an accelerometer, a directional sensor (e.g., compass), a gyroscope, a motion sensor, and/or a biometric sensor). In addition, I/O section 200-12 can be connected with communication unit 200-15 for receiving application and operating system data, using Wi-Fi, Bluetooth, near field communication (NFC), cellular, and/or other wireless (and/or wired) communication techniques.

Memory 200-10 of device 200 can include one or more non-transitory computer-readable storage mediums, for storing computer-executable instructions, which, when executed by one or more computer processors 200-11, for example, cause the computer processors to perform the techniques described below. A computer-readable storage medium can be any medium that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, and Blu-ray technologies, as well as persistent solid-state memory such as flash and solid-state drives. Device 200 is not limited to the components and configuration of FIG. 3, but can include other and/or additional components in a multitude of possible configurations, all of which are intended to be within the scope of this disclosure.

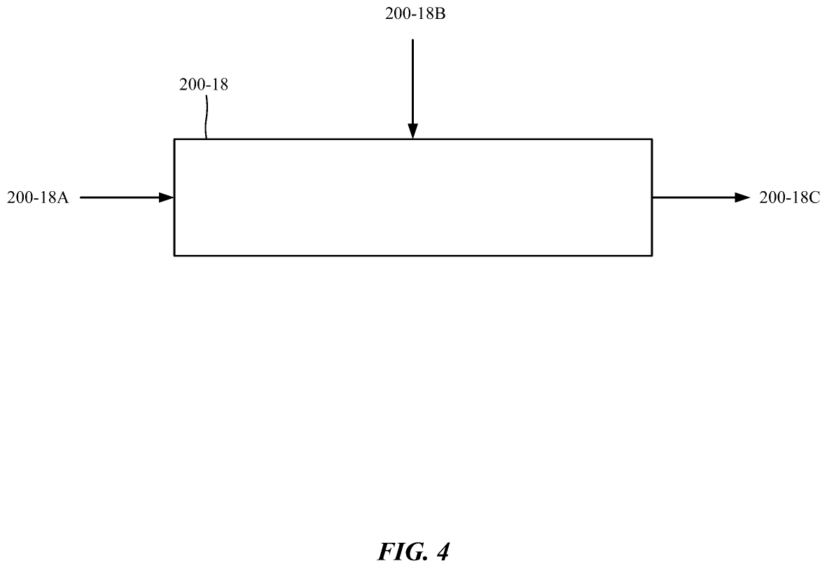

FIG. 4 illustrates a functional diagram of actuator 200-18B in accordance with some embodiments. As described above, actuator 200-18B can be any component that performs physical movement. In some embodiments, actuator 200-18B operates using input that includes control signal 200-18A and/or energy source 200-18B. For example, actuator 200-18 can be a rotary actuator that converts electric energy into rotational movement. This rotational movement can cause the movement of the display portion of device 200 described above with respect to FIGS. 2A-2C (e.g., a counterclockwise rotational movement of the actuator causes device 200 to move to a position having a larger angle (e.g., the second position illustrated in FIG. 2B) and a clockwise (e.g., opposite) rotational movement of the actuator causes device 200 to move to a position having a smaller angle (e.g., the third position illustrated in FIG. 2C)). Control signal 200-18A can indicate one or more start and/or stop instructions, a movement and/or actuation direction, a movement and/or actuation speed, an amount of time to move and/or actuate, a goal position (e.g., pose and/or location) for movement and/or actuation, and/or one or more other characteristics of movement and/or actuation. In some embodiments, the control signal and the energy source are the same signal and/or input. In some embodiments, one or more additional components (e.g., mechanical and/or electric) are coupled (e.g., removably or permanently) to actuator 200-18B for affecting movement and/or actuation (e.g., mechanical linkage such as a lead screw, gears, and/or other component for changing (e.g., converting) a characteristic of movement and/or actuation). In some embodiments, actuator 200-18B includes one or more feedback components (e.g., position sensor, encoder, overcurrent sensor, and/or force sensor) that form part of a feedback loop for modifying and/or ceasing movement and/or actuation (e.g., slowing actuation as a goal position is reached and/or ceasing actuation if physical resistance to actuation is detected via a sensor). In some embodiments, the one or more feedback components are included (e.g., partially and/or wholly) in a movement controller (e.g., movement controller 200-13) operatively coupled to the actuator.

Attention is now turned to functionality (e.g., features and/or capabilities) of one or more devices (e.g., computer system 100 and/or device 200). One such functionality is implementing an “agent,” which can alternatively be referred to as a software agent, an intelligent agent, an interactive agent, a virtual assistant, an intelligent virtual assistant, an interactive virtual assistant, a personal assistant, an intelligent personal assistant, an interactive personal assistant, an intelligent interactive personal assistant, and/or an artificial intelligence (AI) assistant. In some embodiments, an agent refers to a set of one or more functions implemented in hardware and/or software (e.g., locally and/or remotely) on an agent system (e.g., a single device and/or multiple devices). In some embodiments, an agent performs operations to perceive an environment, acquire knowledge, retrieve knowledge, learn skills, interact with users, and/or perform tasks. The agent can, for example, perform these (and/or other) operations in response to user input and/or automatically (e.g., at an appropriate time determined based on a perceived context). A non-exhaustive list of exemplary operations that an agent can be used for and/or with includes: tracking a user's eyes, face, and/or body (e.g., to move with the user and/or identify an intent and/or activity of the user); detecting, recognizing, and/or classifying a user in the environment; detecting and/or responding to input (e.g., verbal input, air gestures, and/or physical input, such as touch input and/or force inputs to physical hardware components (e.g., button, knobs, and/or sliders)); detecting context (e.g., user context, operating context, and/or environmental context); moving (e.g., changing pose, position, orientation, and/or location); performing one or more operations in response to input, context, and/or stimulus (e.g., an object or event (e.g., external and/or internal to a device) that causes one or more responsive operations by a device); providing intelligent interaction capabilities (e.g., due to in part to one or more machine learning (“ML”) models such as a large language model (“LLM”)) for responding and/or causing operations to be performed; and/or performing tasks (e.g., a set of operations for achieving a particular goal) (e.g., automatically and/or intelligently). In some embodiments, an agent performs operations in response to non-contact inputs (e.g., air gestures and/or natural language commands). The preceding list is meant to be illustrative of operations that can be performed using an agent but is not meant to be an exhaustive list. Other operations fall within the intended scope of the capabilities of an agent. Additionally, for the purposes of this disclosure, an agent does not need to include all of the functionality mentioned herein but can include less functionality or more functionality (e.g., an agent can be implemented on an agent system that does not have movement functionality but that otherwise includes an intelligent personal assistant that can interact with a user).

In some embodiments, a user is (e.g., represents, includes, and/or is included in) one or more of a user, person, object, and/or animal in an environment (e.g., a physical and/or virtual environment) (e.g., of the device). In some embodiments, a user is (e.g., represents, includes, and/or is included in) an entity that is perceived (e.g., detected by the device, one or more other devices, and/or one or more components thereof). In some embodiments, an entity is something that is distinguished from surrounding entities (e.g., pieces of environments and/or other users) and/or that is considered as a discrete logical construct via one or more components (e.g., perception components and/or other components). In some embodiments, a user is physical and/or virtual. For example, a physical user can represent a user standing in front of, and being perceived by, the device. As another example, a virtual user can represent an avatar in a virtual scene perceived by the device (e.g., the avatar is detected in a media stream received by the device and/or captured by a camera of the device). Although presented above as examples of a “user,” the terms and/or concepts referred to as “person,” “object,” and/or “animal” can be interchanged with “user” throughout this disclosure, unless explicitly indicated otherwise. For example, use the term “user” can likewise be understood to also refer to “user,” unless explicitly indicated otherwise.

As an example, and referring back to FIGS. 2A-2C, an agent implemented at least partially on device 200 can perform operations that cause display portion 200-1 of device 200 to move with respect to base portion 200-2. For example, the agent detects (e.g., perceives and determines the occurrence of) a context that includes the user standing up (e.g., based on facial detection and tracking); and, in response, the agent causes device 200 to open and/or device 200 opens display portion 200-1 to the larger angle. As another example, the agent can detect verbal input that corresponds to (e.g., is interpreted as and/or that refers to an operation that includes) a request to move the display (e.g., “Please move my display,” or “Please enter sleep mode.”); and, in response, the agent causes device 200 to move and/or device 200 moves display portion 200-1.

FIG. 5 illustrates a functional diagram of an exemplary agent system 200-20. As illustrated in FIG. 5, agent system 200-20 has a dotted box boundary that encloses input devices 200-22, agent components 200-24, and output devices 200-26. In some embodiments, agent system 200-20 includes fewer, more, and/or different components than illustrated in FIG. 5. In some embodiments, agent system 200-20 is implemented on a single device (e.g., computer system 100 and/or device 200). In some embodiments, agent system 200-20 is implemented on multiple devices. In some embodiments, one or more components of agent system 200-20 illustrated in and/or described with respect to FIG. 5 are external to but operatively coupled to agent system 200-20 (e.g., an accessory, an external device, an external sensor, an external actuator, an external display component, an external speaker, and/or an external database). In some embodiments, one or more components of agent system 200-20 are local to one or more other components of agent system 200-20. In some embodiments, one or more components of agent system 200-20 are remote from one or more other components of agent system 200-20.

In some embodiments, input devices 200-22 includes components for performing sensing and/or communications functions of agent system 200-20. As illustrated in FIG. 5, input devices 200-22 includes one or more sensors 200-22A. One or more sensors 200-22A can include any component that functions to detect data corresponding to a physical environment. Examples of one or more sensors 200-22A can include: a camera, a light sensor, a microphone, an accelerometer, a position sensor, a pressure sensor, a temperature sensor, olfactory sensor, and/or a contact sensor. This list is not intended to be exhaustive, and one or more sensors 200-22A can include other sensors not explicitly identified herein that detect, generate, and/or otherwise provide data that can be used (e.g., processed, stored, and/or transformed) for detecting data corresponding to a physical environment. As illustrated in FIG. 5, input devices 200-22 includes one or more communications components 200-22B. One or more communications components 200-22B can include any component that functions to send and/or receive communications (e.g., an antenna, a modem, a network interface component, an encoder, a decoder, and/or a communication protocol stack) internal and/or external to agent system 200-20. Communications components 200-22B can be between different devices and/or between components of the same device. The communications can include control signals and/or data (e.g., messages, instructions, files, application data, and/or media streams). In some embodiments, input devices 200-22 includes fewer, more, and/or different components than those illustrated in FIG. 5. In some embodiments, input devices 200-22 are implemented in hardware and/or software.

In some embodiments, agent components 200-24 includes components that manage and/or carry out functions of an agent of agent system 200-20. As illustrated in FIG. 5, agent components 200-24 includes the following functional components: task flow, coordination, and/or orchestration component 200-24A, administration component 200-24B, perception component 200-24C, evaluation component 200-24D, interaction component 200-24E, policy and decision component 200-24F, knowledge component 200-24G, learning component 200-24H, models component 200-24I, and APIs component 200-24J. Each of these components is described briefly below. Notably, this list of agent components 200-24 is not intended to be exhaustive, and agent components 200-24 can include other functional components not explicitly identified herein that can be used (e.g., processed, stored, and/or transformed) for performing any function of an agent, such as those described herein. In some embodiments, agent components 200-24 includes fewer, more, and/or different components than those illustrated in FIG. 5. In some embodiments, agent components 200-24 is implemented in hardware and/or software.

In some embodiments, task flow, coordination, and/or orchestration component 200-24A performs operations that enable an agent to handle coordination between various components. For example, operations can include handling a data processing task flow to move from perception component 200-24C (e.g., that detects speech input) to models component 200-24I (e.g., for processing the detected speech input using a large language model to determine content and/or intent of the speech input). In some embodiments, task flow, coordination, and/or orchestration component 200-24A performs operations that enable an agent to handle coordination between one or more external components (e.g., resources). For example, FIG. 5 illustrates examples of external components, such as external database 200-30. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, administration component 200-24B performs operations that enable an agent system to handle administrative tasks like managing system and/or component updates, managing user accounts, managing system settings, and/or managing component settings. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, perception component 200-24C performs operations that enable an agent to perceive environmental input. For example, operations can include detecting that a context and/or environmental condition has occurred, detecting the presence of a user (e.g., user, person, object, and/or animal in an environment), detecting an input that includes speech, detecting an input that includes an air gesture, detecting facial expressions, detecting characteristics (e.g., visible and/or non-visible) of a user, and/or detecting verbal and/or physical cues. In some embodiments, perception component 200-24C includes functionality performed by an operating system of a device implementing agent system 200-20. In some embodiments, perception component 200-24C includes functionality performed by one or more applications of a device implementing agent system 200-20.

In some embodiments, evaluation component 200-24D performs operations that enable an agent to process evaluate data (e.g., to determine a context such as a user context, an environmental context, and/or an operating context). For example, operations can include evaluating data gathered from perception component 200-24C, knowledge component 200-24G, external database 200-30, and/or remote processing resource 200-32. In some embodiments, evaluation component 200-24D includes functionality performed by an operating system of a device implementing agent system 200-20. In some embodiments, evaluation component 200-24D includes functionality performed by one or more applications of a device implementing agent system 200-20.

Reference is made herein to environmental context (also referred to herein as a “context of an environment” and/or “a context corresponding to an environment”). In some embodiments, an environmental context is a context based on one or more characteristics of the environment (e.g., users, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) using one or more of detecting input (e.g., via one or more input devices) and/or receiving data (e.g., from one or more other devices and/or components in communication with the device).

Reference is made herein to user context (also referred to herein as a “context of a user” and/or “a context corresponding to a user”) (and/or a user context). In some embodiments, a user context is a context based on one or more characteristics of the user (and/or a user). For example, a user context can include the user's appearance and/or clothing, personality, actions, behavior, movement, location, and/or pose. In some embodiments, a device (e.g., using an agent) determines a user context (e.g., to be currently true, occurring, and/or applicable) using one or more of detecting input (e.g., via one or more input devices) and/or receiving data (e.g., from one or more other devices and/or components in communication with the device). In some embodiments, a device determines user context based on historical context and/or learned characteristics of the user, where one or more characteristics of the user are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include the internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) using one or more of detecting input (e.g., via one or more input devices) and/or receiving data (e.g., from one or more other devices and/or components in communication with the device). In some embodiments, a device (e.g., using an agent) determines an operational context (e.g., to be currently true, occurring, and/or applicable) using one or more internal states (e.g., accessed, retrieved, and/or queried by a process of the device).

In some embodiments, interaction component 200-24E performs operations that enable an agent to manage and/or perform interactions with users. For example, operations can include determining an appropriate interaction model for a particular context and/or in response to a particular input. In some embodiments, interaction component 200-24E includes functionality performed by an operating system of a device implementing agent system 200-20. In some embodiments, interaction component 200-24E includes functionality performed by one or more applications of a device implementing agent system 200-20.

In some embodiments, policy and decision component 200-24F performs operations that enable an agent to take actions in view of available data. For example, operations can include determining which operations to perform and/or which functional components to utilize in response to a detected context. In some embodiments, policy and decision component 200-24F includes functionality performed by an operating system of a device implementing agent system 200-20. In some embodiments, policy and decision component 200-24F includes functionality performed by one or more applications of a device implementing agent system 200-20.

In some embodiments, knowledge component 200-24G performs operations that enable an agent to access and use stored knowledge. For example, operations can include indexing, storing, and/or retrieving data from a data store, a database, and/or other resource. In some embodiments, knowledge component 200-24G includes functionality performed by an operating system of a device implementing agent system 200-20. In some embodiments, knowledge component 200-24G includes functionality performed by one or more applications of a device implementing agent system 200-20.

In some embodiments, learning component 200-24H performs operations that enable an agent to learn through experiences. For example, operations can include observing and/or keeping track of data that includes preferences, routines, user characteristics, and/or environmental characteristics in a manner in which such data can be used to inform future operation by the agent and/or a component thereof (e.g., such as when performing tasks and/or interactions with users). In some embodiments, learning component 200-24H includes functionality performed by an operating system of a device implementing agent system 200-20. In some embodiments, learning component 200-24H includes functionality performed by one or more applications of a device implementing agent system 200-20.

In some embodiments, models component 200-24I performs operations that enable an agent to apply ML models (e.g., such as a large language model (LLM)) to process data. For example, operations can include storing ML models, executing ML models, training and/or re-training ML models, and/or otherwise managing aspects of implementing ML models. In some embodiments, models component 200-24I includes functionality performed by an operating system of a device implementing agent system 200-20. In some embodiments, models component 200-24I includes functionality performed by one or more applications of a device implementing agent system 200-20.

In some embodiments, agent system 200-20 responds to natural language input. For example, agent system 200-20 responds to a natural language input that is in the form of a statement, a question, a command, and/or a request. In some embodiments, agent system 200-20 outputs text and/or speech output that is provided in a natural language or mimicking a natural language style. For example, agent system 200-20 can process the natural language question “How hot is it outside?” with a speech response that indicates the current temperature outside at the user's location (e.g., “It is 18 degrees outside.”). In some embodiments, agent system 200-20 responds to natural language input by providing information (e.g., weather, travel, and/or calendar information) and/or performing a task (e.g., opening a document, searching a database, and/or opening an application).

In some embodiments, agent system 200-20 includes and/or relies on one or more data models to process input (e.g., natural language input, gesture input, visual input, and/or other data input) and/or provide output (e.g., output of information via natural language output, visual output, audio output, and/or textual output). Such data models can include and/or be trained using user data (e.g., based on particular interactions and/or data from the user being interacted with) and/or global data (e.g., general data based on interactions and/or data from many users). For example, user data (e.g., preferences, previous use of language and/or phrases, calendar entries, a contact list, and/or activity data) can be used to better infer user intent and/or provide responses that are more likely to address a user's request. In some embodiments, data models used by agent system 200-20 include, are used by, and/or are implemented using one or more machine learning components (e.g., hardware and/or software) (e.g., one or more neural networks). Such machine learning components can be used to process verbal input to determine words and/or phrases therein, one or more contexts that correspond to the words, a user intent corresponding to the words, one or more confidence scores, and/or a set of one or more actions to take in response to the verbal input. Analogous operations can be performed to process other types of inputs, such as visual input, data input, and/or textual input. Such data models can include machine learning and/or data processing models, including, but not limited to, natural language processing models, language models, speech recognition models, object recognition models, visual processing models, ontologies, task flow models, and/or intent recognition models (e.g., used to determine user intent).

In some embodiments, Application Programming Interfaces (APIs) component 200-24J

performs operations that enable an agent to interface with services, devices, and/or components. For example, operations can include relaying data (e.g., requests, responses, and/or other messages) between data interfaces (e.g., between software programs, between a system process and application process, between system processes, between application processes, between communication protocols, between a client and a server, between file systems, and/or between components on different sides of a trust boundary). In some embodiments, the data interfaces served by APIs component 200-24J are local (e.g., to the device, such as two application processes exchanging data) and/or remote (e.g., from the device, such as interfacing with a web service via a remote server). In some embodiments, APIs component 200-24J includes functionality performed by an operating system of a device implementing agent system 200-20. In some embodiments, APIs component 200-24J includes functionality performed by one or more applications of a device implementing agent system 200-20.

In some embodiments, output devices 200-26 includes components for performing output functions of agent system 200-20. The exemplary output devices illustrated in FIG. 5 are described briefly below. In some embodiments, output devices 200-26 include fewer components, more, and/or different components than those illustrated in FIG. 5. In some embodiments, output devices 200-26 are implemented in hardware and/or software.

As illustrated in FIG. 5, output devices 200-26 includes one or more visual output devices 200-26A. One or more visual output devices 200-26A can include any component that functions to output (e.g., generate, create, and/or display), and/or cause output of, a visual output (e.g., an output that is visually perceptible, such as graphical user interface, playback of visual media content, and/or lighting). Examples of one or more visual output devices 200-26A can include: a display component, a projector, a head mounted display (HMD), a light-emitting diode (“LED”), and/or a component that creates visually perceptible effects (e.g., movement). This list is not intended to be exhaustive, and one or more visual output devices 200-26A can include other visual output devices not explicitly identified herein that detect, generate, and/or otherwise provide data that can be used (e.g., processed, stored, and/or transformed) for outputting visual output.

As illustrated in FIG. 5, output devices 200-26 include one or more audio output devices 200-26B. One or more audio output devices 200-26B can include any component that functions to output (e.g., generate and/or create), and/or cause output of, an audio output (e.g., an output that is audibly perceptible, such as a sound, music, speech, and/or audio media content). Examples of one or more audio output devices 200-26B can include: a speaker, an audio amplifier, a tone generator, and/or a component that creates audibly perceptible effects (e.g., movement such as vibrations). This list is not intended to be exhaustive, and one or more audio output devices 200-26B can include other audio output devices not explicitly identified herein that detect, generate, and/or otherwise provide data that can be used (e.g., processed, stored, and/or transformed) for outputting audio output.

As illustrated in FIG. 5, output devices 200-26 include one or more movement output devices 200-26C (also referred to herein as a “movement component”). One or more movement output devices 200-26C can include any component that functions to output (e.g., generate and/or create), and/or cause output of, a movement output (e.g., an output that includes physical movement of the device and/or another device/component). Examples of one or more movement output devices 200-26C can include: a movement controller, an actuator, a mechanical linkage, an electromechanical device, and/or a component that creates physical movement. This list is not intended to be exhaustive, and one or more movement output devices 200-26C can include other movement output devices not explicitly identified herein that detect, generate, and/or otherwise provide data that can be used (e.g., processed, stored, and/or transformed) for outputting movement output. As illustrated in FIG. 5, output devices 200-26 include one or more haptic output devices 200-26D. One or more haptic output devices 200-26D can include any component that functions to output (e.g., generate, create, and/or display), and/or cause output of, a haptic output (e.g., an output that is physically perceptible using tactile sensation, such as a vibration, pressure, texture, and/or shape). Examples of one or more haptic output devices 200-26D can include: a speaker, a component that generates vibrations, a component that generates texture changes, a component that generates pressure changes, and/or a component that creates perceivable tactile effects. This list is not intended to be exhaustive, and one or more haptic output devices 200-26D can include other haptic output devices not explicitly identified herein that detect, generate, and/or otherwise provide data that can be used (e.g., processed, stored, and/or transformed) for outputting haptic output.

As illustrated in FIG. 5, output devices 200-26 include one or more communications components 200-26E. One or more communications components 200-26E can include any component that functions to send and/or receive communications (e.g., an antenna, a modem, a network interface component, an encoder, a decoder, and/or a communication protocol stack) internal and/or external to agent system 200-20. In some embodiments, the communications can be between different devices and/or between components of the same device. In some embodiments, the communications can include control signals and/or data (e.g., messages, instructions, files, application data, and/or media streams). In some embodiments, one or more communications components 200-26E includes one or more features of one or more communications components 200-22B (e.g., as described above). In some embodiments, one or more communications components 200-26E are the same as one or more communications components 200-22B (e.g., one or more components that handle communication inputs and outputs and thus be considered as either and/or both an input device and an output device).

Throughout this disclosure, reference can be made to movement output (e.g., referred to in various forms such as: movement, device movement, output of movement, device motion, output of motion, and/or motion output). In some embodiments, outputting (e.g., causing output of) movement refers to movement of an electronic device (e.g., a portion or component thereof relative to another portion and/or of the whole electronic device). For example, referring back to FIG. 2B, movement output can refer to device 200 actuating movement component 200-3 to move display portion 200-1 to the position illustrated in FIG. 2B (e.g., from the position in FIG. 2A). In some embodiments, movement output is not (e.g., does not include and/or does not only include) haptic output (e.g., haptic movement output). In some embodiments, movement output is not (e.g., does not include and/or does not only include) vibration output. In some embodiments, movement output is not (e.g., does not include and/or does not only include) oscillating movement (e.g., movement of an actuator that merely causes vibration by moving a component repeatedly along a path that is internal to the device). In some embodiments, movement output includes (e.g., requires and/or results in) changing a location and/or pose of at least a portion of (and/or the entirety of) a component or the electronic device. In some embodiments, movement output includes output that moves at least a portion of (and/or the entirety of) a component or the electronic device from a first location and/or first pose to a second location and/or second pose. For example, with respect to FIGS. 2A-2C, display portion 200-1 is shown in a different location (e.g., in space) and pose (e.g., relative to base portion 200-2) in each of FIGS. 2A, 2B, and 2C. In some embodiments, movement output includes output that moves at least a portion (and/or the entirety of) a component or the electronic device to a third location and/or third pose (e.g., from the first location and/or first pose and/or from the second location and/or the second pose). In some embodiments, the third location and/or the third pose is the same as the first location and/or first pose and/or as the second location and/or the second pose. For example, movement output can include device 200 in FIG. 2A beginning from the first position illustrated in FIG. 2A, moving to the second position illustrated in FIG. 2B, and moving to return to the first position illustrated in FIG. 2A. For example, movement output can include device 200 in FIG. 2A beginning from the first position illustrated in FIG. 2A, moving to the second position illustrated in FIG. 2B, and continuing movement to come to rest at the third position illustrated in FIG. 2C.

Throughout this disclosure, an electronic device can be illustrated in (and/or described as being in) different locations and/or poses at different times. For example, in FIG. 2A illustrates device 200 in the first position, FIG. 2B illustrates device 200 in the second position, and FIG. 2A illustrates device 200 in the third position. In some embodiments, the electronic device moves itself between such locations and/or poses (e.g., using movement output). For example, device 200 moves from the first position to the second position under its own power (e.g., using a power source and one or more actuators to cause movement). In particular, any example herein that illustrates and/or describes an electronic device being at different locations and/or poses (e.g., at different times) should be understood to cover a scenario in which the device moved itself between such locations and/or poses (e.g., unless otherwise clearly indicated).

Throughout this disclosure, reference can be made to “performing output,” “causing output,” and/or “outputting” (e.g., by one or more output generation devices and/or by one or more output generation components) (and/or similar such phrases). In some embodiments, outputting (e.g., or the aforementioned variants) includes (and/or is) outputting movement (e.g., movement output as described above).

Throughout this disclosure, reference can be made to “displaying,” “causing display of,” and/or “outputting visual content” (e.g., by one or more display components) (and/or similar such phrases). In some embodiments, displaying (e.g., or the aforementioned variants) includes displaying visual content in connection with outputting movement (e.g., movement output as described above).

Throughout this disclosure, reference can be made to “outputting audio,” “causing output of audio,” and/or “providing audio output” (e.g., by one or more audio generation components and/or by one or more audio output devices) (and/or similar such phrases). In some embodiments, outputting audio (e.g., or the aforementioned variants) includes outputting audio content in connection with outputting movement (e.g., movement output as described above).

Throughout this disclosure, reference can be made to movement of an avatar (e.g., or other representation of a user, an agent and/or a character that is displayed) (e.g., by one or more display components) (and/or similar such phrases). In some embodiments, moving an avatar (e.g., or the aforementioned variants) includes displaying movement of visual content in connection with outputting movement (e.g., movement output as described above). For example, displaying an avatar nodding in agreement can include movement of the electronic device in a similar manner as the avatar movement (e.g., mimicking nodding). In some embodiments, moving an avatar (e.g., or the aforementioned variants) includes outputting movement (e.g., movement output as described above) without displaying movement of visual content. For example, a device can perform movement output that mimics nodding without moving a displayed avatar (e.g., the avatar does not move relative to the display). As illustrated in FIG. 5, agent system 200-20 can optionally interface with external components such as external database 200-30, remote processing component 200-32, and/or remote administration component 200-34. In some embodiments, external database 200-30 represents one or more functions that provide data storage resources accessible to agent system 200-20. In some embodiments, access to the data of external database 200-30 is provided directly to agent system 200-20 (e.g., the agent system manages the database) and/or indirectly to agent system 200-20 (e.g., a database is managed by a different system, but data stored therein can be provided and/or stored for use by agent system 200-20). In some embodiments, external database 200-30 is dedicated to (e.g., only for use by) agent system 200-20, is not dedicated to agent system 200-20 (e.g., is a database of a web service accessible to different agent systems), and/or is a combination of both dedicated and non-dedicated database resources. In some embodiments, remote processing component 200-32 represents one or more components that function as a data processing resource that is accessible to agent system 200-20. In some embodiments, access to remote processing component 200-32 is provided directly to agent system 200-20 (e.g., the agent system manages the processing resources) and/or indirectly to agent system 200-20 (e.g., a processing resource managed by a different system, but that can provide data processing for the benefit of agent system 200-20). In some embodiments, remote processing component 200-32 is dedicated to (e.g., only for use by) agent system 200-20, is not dedicated to agent system 200-20 (e.g., is a processing resource of a web service accessible to different agent systems), and/or is a combination of both dedicated and non-dedicated processing resources. Examples of data processing include processing image data (e.g., for feature extraction and/or object detection), processing audio data (e.g., for processing natural language speech input via a large language model), and/or training a machine learning algorithm and/or model. In some embodiments, remote administration component 200-34 represents functions that include and/or are related to administrative functions. For example, such administrative functions can include providing component updates to agent system 200-20 (e.g., software and/or firmware updates), managing accounts (e.g., permissions, access control, and/or preferences associated therewith), synchronizing between different agent systems and/or components thereof (e.g., such that an agent accessible via multiple devices of a user can provide a consistent user experience between such devices), managing cooperation with other services and/or agent systems, error reporting, managing backup resources to maintain agent system reliability and/or agent availability, and/or other functions required by agent system 200-20 to perform operations, such as those described herein.

The various components of agent system 200-20 described above with respect to FIG. 5 represent functional blocks that represent functionality. This functionality can be implemented on the same and/or different hardware (e.g., physical components) and/or by the same and/or different software. For example, the functional blocks can be implemented using one or more physical components, devices (e.g., computer system 100 and/or device 200), and/or software programs. In other words, each functional block does not necessarily represent a single, discrete physical component, device, and/or software program, but can be implemented using one or more of these. Further, agent system 200-20 can include multiple implementations of functionality represented by a respective functional block. For example, agent system 200-20 can include multiple different model components representing ML models that are used in different contexts, can include multiple different API components representing different APIs that are used for different services, and/or can include multiple different visual output devices that are used for outputting different types of visual output.

Attention is now turned to discussion of concepts that can arise with respect to operation of an agent.

As discussed throughout, an agent can be capable of interacting with a user. In some embodiments, this capability includes the ability to process explicit requests, commands, and/or statements. In some embodiments, explicit requests, commands, and/or statements include and/or are interpreted as instructions directed to accomplishing a task (e.g., display X, complete task Y, and/or perform operation Z). In some embodiments, an agent includes the ability to process implicit requests, commands, and/or statements. In some embodiments, an implicit request, command, and/or statement does not include an explicit request, command, and/or statement. For example, “I like going to Europe,” can be interpreted as an implicit request, command, and/or statement which, in response to detecting, device 200 displays an itinerary in response to the statement. As another example, “This picture is for my grandmother,” can be interpreted as an implicit request, command, and/or statement which, in response to detecting, device 200 displays suggestions for modifying the picture). As another example, “I'm so tired,” can be interpreted as an implicit request, command, and/or statement which, in response to detecting, device 200 causes a sleep meditation application to begin a meditation session. As yet another example, “I miss my grandad” can be interpreted as an implicit request, command, and/or statement when, in response to detecting, device 200 can initiate a live communication session (e.g., telephone call, video call, and/or text messaging session) with grandad. In some embodiments, an implicit request is more likely to be processed according to one or more current environmental context, operational context, and/or user context, while an explicit request is less likely to be processed according to one or more current environmental context, operational context, and/or user context. For example, the phrase, “call my grandad,” can be an explicit request, and in response to detecting the request, device 200 will initiate a live communication session with grandad, irrespective of one or more current environmental context, operational context, and/or user context. However, the phrase, “I miss my grandad,” can be an implicit request, and in response to detecting the request, device 200 can display a list of gifts to buy for grandad if a user has been recently talking about buying gifts or could call grandad in another context that does not include the user recently discussing buying gifts. In some embodiments, a request can include one or more explicit requests and one or more implicit requests. In some embodiments, an implicit request is responded to independently from an explicit request; and in other embodiments, a response to an implicit request is dependent on an explicit request.

Reference can be made herein to a response by an agent that is output by a device. In some embodiments, a response includes an audio portion (e.g., audio output, acoustic output, sound, and/or speech) (also referred to herein as a “verbal response,” an “audio response,” and/or an “acoustic response) and/or a visual portion (e.g., display and/or movement of a representation and/or avatar). In some embodiments, a response includes a movement portion (e.g., movement of the device). In some embodiments, a response includes a haptic portion (e.g., touch and/or vibration).

Reference can be made herein to an internal dialogue, internal context, and/or an operational context, which can refer to a dynamic context or dynamic decision-making process of the device, an internal state of device 200, and/or internal data the device is partially basing its decision on. In some embodiments, an internal dialogue includes a set of one or more rules, characteristics, detections, and/or observations that the computer system uses to generate a response to one or more commands, questions, and/or statements). In some embodiments, the set of one or more rules, characteristics, detections, and/or observations are learned and/or generated via deep learning and/or one or more machine learning algorithms, and/or using one or more machine learning and/or system agents. In some embodiments, an internal dialogue is generated in real-time. In some embodiments, an internal dialogue is locally stored and/or stored via the cloud. In some embodiments, an internal dialogue can be modified, updated, and/or deleted. In some embodiments, an internal dialogue is generated based on other internal dialogues.

Reference can be made herein to personality and/or behavior (or a representation of personality/behavior) (e.g., of an agent, user, and/or character). In some embodiments, personality and/or behavior refers to a set of one or more characteristics that the device detects, has knowledge of, conforms to, applies, and/or tracks. In some embodiments, the personality or behavior is used as basis to perform operations. For example, an agent can detect a user's personality and respond in a manner based on the personality (e.g., output different responses in response to different user personalities). As another example, the agent can output a response having characteristics that correspond to one or more characteristics that correspond to the personality and/or behavior (e.g., output a response in different ways that depend on personality of the agent). In some embodiments, such characteristics represent and/or mimic personality of a user, such as how the user acts and/or speaks. In some embodiments, such characteristics approximate a user's personality.

In some embodiments, an agent is a system agent. In some embodiments, a system agent is an agent that corresponds to a process that originates from and/or is controlled by an operating system of the device (e.g., the device implementing the agent). In some embodiments, an agent is an application agent. In some embodiments, an application agent is an agent that corresponds to a process that originates from and/or is controlled by an application of (e.g., installed on and/or executed by) the device (e.g., the device implementing the agent).

Reference can be made herein to a representation (e.g., an avatar and/or avatar representation) of an agent (e.g., and/or of a user (e.g., person, object, and/or an animal) and/or a user interface object (e.g., an animated character)). In some embodiments, a representation of an agent refers to a set of output characteristics (e.g., visual and/or audio) of the agent (and/or the user and/or the user interface object). For example, a representation of an agent can include (and/or correspond to) a set of one or more visual characteristics (e.g., facial features of an animated face) and/or one or more audio characteristics (e.g., language and voice characteristics of audio output). In some embodiments, a representation (e.g., of an agent) is used to represent output by the agent. For example, a device implementing an interactive agent outputs audio in a voice of the agent and displays an animated face of the agent moving in a manner to simulate the agent speaking the audio output. In this way, a user can feel like they are having a normal conversation with the agent. In some embodiments, a representation of an agent is (or is not) inclusive of personality and/or behavior characteristics (e.g., as described above). For example, a representation of an agent can include (and/or correspond to) a set of visual characteristics (e.g., facial features of an animated face) and also a set of personality characteristics. In some embodiments, a representation of an agent includes a set of user characteristics that correspond to visual representation of a user (e.g., representations of a user's appearance, voice, and/or personality are used as an avatar that appears to move and/or speak). In some embodiments, a representation is a representation of a face (e.g., a user interface object that is output having features that simulate a face and/or facial expressions of a person (e.g., for conveying information to a viewer)).

In some embodiments, a character (e.g., of an agent and/or avatar) refers to a particular set of characteristics of a representation. For example, an avatar can take on (e.g., use, apply, interact with, and/or output according to) characteristics of a fictional and/or non-fictional character (e.g., from a movie, a show, a book, a series, and/or popular culture).

In some embodiments, a voice (e.g., of an agent and/or avatar) refers to a set of one or more characteristics corresponding to sound output that resembles (e.g., represents, mimics, and/or recreates) vocal utterance (e.g., attributable and/or simulated as being output by an agent and/or avatar). For example, device 200 can output a sentence that sounds different depending on a voice used. In some embodiments, a particular character and/or avatar can be configured to use a particular voice (e.g., have a corresponding voice). In some embodiments, the particular voice can mimic a user's voice.

In some embodiments, an appearance (e.g., of an agent and/or avatar) refers to a set of one or more characteristics corresponding to visual output that represents an avatar (and/or an agent). For example, device 200 can output an avatar that has a set of facial features forming an appearance that resembles a particular character from a movie.

In some embodiments, an expression of an avatar refers to a set of one or more characteristics corresponding to a particular visual appearance of a user, an avatar, and/or an agent. For example, device 200 can output an avatar that has a set of facial features arranged in a particular way to give the appearance of a facial expression (e.g., which can be used as a form of non-verbal communication to a user) (e.g., a frown is an expression of sadness, a smile is an expression of happiness, and/or wide open eyes is an expression of surprise). As another example, device 200 can output an avatar that has a set of body features (e.g., arms and/or legs) arranged in a particular way to give the appearance of a body expression (e.g., which can be used as a form of non-verbal communication to a user) (e.g., a hand gesture is an expression of approval, covering eyes is an expression of fear, and/or shrugging shoulders is an expression of lack of knowledge). In some embodiments, an expression includes movement (e.g., a head nod is an expression of agreement and/or disagreement) of the avatar. In some embodiments, device 200 can move, via the movement component, to indicate an expression with or without the avatar moving. In some embodiments, an agent performs one or more operations that depend on a user's expression (e.g., detects if a person is sad and responds with a kind statement or question). In some embodiments, expressions (e.g., whether and/or how they are used and/or how they are output) depends on personality. For example, a first personality can use a particular expression more than a second personality. As another example, an expression (e.g., frown, smile, and/or how wide eyes are opened) for the first personality can appear different from the expression (and/or a similar and/or equivalent expression) for a second personality (e.g., the first personality smiles in a manner that reveals teeth, but the second personality smiles without revealing teeth).

In some embodiments, an agent (e.g., an avatar of the agent and/or an agent system (e.g., hardware and/or software) implementing the agent) mimics characteristics of another user, agent, and/or character (e.g., in personality, behavior, expressions, and/or voice). In some embodiments, mimicking includes mirroring a user (e.g., copying use of a phrase and/or movement detected from a user interacting with the agent). In some embodiments, mimicking characteristics of a user includes attempting to reproduce the characteristics of the user (e.g., in the exact same manner and/or in manner that resembles the characteristics but is not an exact reproduction of the characteristics). For example, an agent mimicking voice and/or expressions does not require the agent have the exact same voice and/or expressions as the user being mimicked (e.g., but rather simply resembles the user's voice and/or expressions).

In some embodiments, a component and/or device uses (e.g., performs operations, makes decisions, and/or determines context based on) learned characteristics (e.g., characteristics of a context, user, and/or environment that the device has learned over time (e.g., via detection, prior experience, and/or feedback (e.g., from one or more users)). For example, characteristics learned over time can include a user's routine. In such example, if a particular user asks an agent for a summary of any new messages for the user at the same time every day, the agent can learn to perform operations automatically based on the learned characteristics of the routine (e.g., what data is needed, when the data is needed, and/or for which user). In some embodiments, use of learned characteristics enables an agent (and/or device) to improve understanding of (and/or responses to) a context, user, and/or environment, and/or to understand a context, user, and/or environment that otherwise was not (and/or would not be) understood (e.g., not responded to or responded to incorrectly). In some embodiments, learned characteristics are formed (e.g., by and/or for an agent) using reinforcement learning. In some embodiments, learned characteristics correspond to one or more levels of confidence, certainty, and/or reward (e.g., that are shaped by one or more reward functions). In some embodiments, learned characteristics (and/or how they are used to affect output of an agent and/or device) can change over time (e.g., levels confidence, certainty, and/or reward change over time). For example, output of a device before learning a set of learned characteristics can be different from output of the device after learning the set of learned characteristics. In some embodiments, a component and/or device uses learned knowledge. For example, similar to described above with respect to learned characteristics, learned knowledge can refer to information used to update (e.g., enhance, add to, and/or augment) a knowledge base of a device (e.g., for use by an agent implemented thereon). In some embodiments, multiple sets of learned characteristics for a user can be stored and/or used. In some embodiments, different sets of learned characteristics for different users can be stored and/or used.

Reference can be made herein to interaction with an agent (and/or a device). In some embodiments, an interaction refers to a set of one or more inputs and/or outputs of a device implementing the agent and one or more users. For example, an interaction can be an input by a user (e.g., “Please turn on the lights”) and a corresponding output (e.g., causing the lights to turn on and/or a response by the device of “Okay”). In some embodiments, interaction can include multiple inputs/outputs by one or more of the parties to the interaction (e.g., device and/or users). For example, an interaction can include a first input by a user (e.g., “Please turn on the lights”) and a corresponding first output (e.g., “Which lights?”), and also include a second input by the user (e.g., “Kitchen lights”) and a second output from the device (e.g., “Okay”). In some embodiments, which inputs and/or outputs are considered together as an interaction is based on a logical and/or contextual grouping (e.g., interactions within the previous thirty (30) seconds and/or interactions relating to turning on the lights). As one of skill will appreciate, an interaction can be considered in a manner that depends on the implementation (e.g., determining when an interaction is complete can involve determining if the user still present (e.g., speaking at all) and/or if the user still talking about the lights or has moved onto a different topic). In some embodiments, an interaction is a current interaction (e.g., ongoing, presently occurring, and/or active). In some embodiments, an interaction is a previous interaction. The examples above describe a device having a conversation with a user. In some embodiments, a conversation is between two or more users (e.g., users in an environment). For example, a device can detect a conversation between to users (e.g., the users are directing speech and responses to each other, rather than to the device).

In some embodiments, an agent (and/or device) determines and/or performs an operation based on an intent corresponding to a user. For example, a device detects user input and outputs a response that depends on an intent of the user input. For example, a device detects user input that includes a pointing gesture detected together with verbal instruction to “turn on that light,” and in response, the device turns on the light that is determined to correspond to the intent of the input (e.g., the light toward which the pointing gesture directed). In some embodiments, intent is determined (e.g., by the device that detects input and/or by one or more other devices) using one or more of: one or more inputs, knowledge (e.g., learned knowledge about a user based on a history of observed behavior, personality, and interactions), learned characteristics, and/or context. In some embodiments, intent is determined from one or more types of input (e.g., verbal input, visual input via a camera, and/or contextual input).

Attention is now directed towards embodiments of user interfaces (“UI”) and associated processes that are implemented on an electronic device, such as computer system 100 and/or device 200.

FIGS. 6A-6K illustrate computer system 600 as a tablet. It should be recognized that computer system 600 can be other types of computer systems such as a smartphone, a smart watch, a laptop, a communal device, a smart speaker, an accessory, a personal gaming system, a desktop computer, a fitness tracking device, and/or a head-mounted display (HMD) device. In some embodiments, computer system 600 belongs to, is logged into a user account corresponding to, and/or is being used by Jane. In some embodiments, computer system 600 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 600 includes and/or is in communication with one or more output devices (e.g., a display screen, a projector, a touch-sensitive display, a speaker, and/or a movement component). In some embodiments, computer system 600 includes one or more components and/or features described above in relation to computer system 100 and/or electronic device 200. In some embodiments, computer system 600 is, includes, implements, and/or is in communication with one or more agent systems as described above with respect to FIG. 5 (e.g., referred to as “the agent” below).

FIGS. 6A-6K are split between a left side to illustrate outputs of computer system 600 and a right side to illustrate a person (e.g., subject 606, referred to as Jane) in a physical environment. While FIGS. 6A-6K illustrate computer system 600 outputting particular content, it should be recognized that such content is merely for explanatory purposes and that such content can be in different forms, at different locations, at different sizes, include different content, and/or that more, fewer, and/or different content can be output in accordance with techniques described herein. In some embodiments, subject 606 and computer system 600 are both within the physical environment (e.g., subject 606 is standing and/or walking in front of computer system 600).

While the examples in FIGS. 6A-6K include computer system 600 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, inputs detected by computer system 600 are passive inputs that are not purposefully directed at computer system 600 by a subject (e.g., a person, an animal, an object, and/or a device). Examples of such inputs include, but are not limited to, motion of the subject through the physical environment, location of the subject within the physical environment, direction that the subject is facing and/or looking, light levels within the physical environment, and/or sound levels within the physical environment.

As illustrated in FIG. 6A, computer system 600 displays agent user interface 602. Agent user interface 602 includes time indicator 602 a (e.g., “9:23”) and agent representation 604. Agent representation 604 is a visual representation of the agent. As illustrated in FIG. 6A, agent representation 604 is displayed as a square in a middle portion of agent user interface 602. In other embodiments, agent representation 604 is displayed in a different manner, such as a triangle occupying a portion of the bottom right corner of agent user interface 602 or with facial features that can be animated to give the impression of facial expressions and/or speech. In some embodiments, computer system 600 does not display agent representation 604 within agent user interface 602, such as when agent representation 604 would be in the way of other user interface elements or when the agent is not currently active.

As illustrated on the right side of FIG. 6A, Jane is standing near computer system 600. At FIG. 6A, while displaying agent user interface 602, computer system 600 detects input 605a. Input 605a is illustrated as a verbal input in which Jane requests that computer system 600 monitor her snacking habits for one week (e.g., Jane states “I think I've been snacking too much. Please monitor my snacking for one week.”). It should be recognized that one or more other input types can be used. For example, while displaying agent user interface 602, computer system 600 can detect a tap input within a health application to monitor snacking.

As illustrated in FIG. 6A, as part of (e.g., while or in response to) detecting input 605a, computer system 600 displays snacking indicator 602b. In some embodiments, snacking indicator 602b is an indication of a keyword (e.g., “Snacking”) that computer system 600 determines is a focal point of input 605a. In other embodiments, snacking indicator 602b is an indication that the agent has determined to monitor Jane's snacking.

At FIG. 6A, in response to detecting input 605a, computer system 600 begins a process of monitoring Jane's snacking habits over the course of one week. In some embodiments, the subject that performs input 605a is a different subject than the subject for whom computer system 600 tracks snacking habits. In such embodiments, computer system 600 creates a snacking summary for a subject other than the subject that made the request. For example, Jane performs input 605a, but computer system 600 tracks the snacking habits of another person.

FIG. 6B takes place at a time after FIG. 6A, as indicated by time indicator 602a progressing to 11:19. At FIG. 6B, computer system 600 is monitoring Jane's snacking behavior. As illustrated on the right side of FIG. 6B, Jane is drinking smoothie 608.

As illustrated on the left side of FIG. 6B, computer system 600 displays agent representation 604 as a triangle pointing in the direction of Jane to indicate that the attention of agent representation 604 is directed toward the actions of Jane. In some embodiments, computer system 600 moves one or more movement components of computer system 600 to track movements of Jane throughout the physical environment in order to observe her actions. For example, computer system 600 can rotate a movement component so that Jane is maintained in a field of view of one or more cameras of computer system 600 as she walks by. Similar to as described above, computer system 600 can display agent representation 604 in a different way than the triangle, such as to include one or more facial features (e.g., eyes, eyebrows, a nose, and/or a mouth) directed towards Jane. For example, agent representation 604 can include a representation of eyes looking to the right.

As illustrated at FIG. 6B, computer system 600 displays agent user interface 602 as including monitoring indicator 602c (e.g., “Snack Watch”). At FIG. 6B, monitoring indicator 602c corresponds to the activity being monitored by computer system 600 as requested by Jane (e.g., input 605a to monitor Jane's snacking). In some embodiments, computer system 600 displays monitoring indicator 602c for each instance during a recorded instance of Jane snacking. It should be noted that the content of monitoring indicator 602c depends on the type of monitoring currently occurring. For example, if Jane requested that computer system 600 monitor her medication intake, computer system 600 displays monitoring indicator 602c as “Taking Medication” while detecting Jane taking medication.

At FIG. 6B, while computer system 600 monitors Jane drinking smoothie 608, computer system 600 records the instance as a snack. In some embodiments, computer system 600 records an instance of snacking by detecting Jane's movements in the physical environment. For example, if Jane walks by computer system 600 towards the pantry, computer system 600 can infer that Jane had a snack. In some embodiments, computer system 600 can record a snacking activity based on what Jane is doing in the physical environment besides eating. For example, if Jane walks by computer system 600 while holding a bag of chips but not eating them, computer system 600 can record the moment as an instance of snacking.

In some embodiments, after one week of monitoring snacking behavior, computer system 600 outputs a summary of the snacking behavior. For example, computer system 600 displays a summary of data of each instance of snacking. In this example, the summary includes a summary of when snacks are generally consumed. In another example, computer system 600 outputs an audio summary of the snacking behavior. In another example, computer system 600 displays the summary and includes a picture of each instance of snacking. In some embodiments, computer system 600 outputs the summary at a time that Jane is detected near computer system 600. In some embodiments, computer system 600 outputs the summary in response to detecting a request to output the summary. For example, Jane's computer system can output the summary in response to detecting a verbal input such as, “What has my snacking looked like recently?” from Jane.

In some embodiments, computer system 600 outputs summaries of the snacking behavior periodically during the one-week time requested by Jane. For example, computer system 600 can output a summary during each instance of snacking. In this example, the summary at each instance of snacking can include the number of snacks that day, what snacking activity computer system 600 is currently recording, and/or indicate if the snack is healthy (e.g., “An apple is healthy but is still a snack”). In another example, computer system 600 outputs a summary after 2 days of snack monitoring. In another example, computer system 600 outputs a summary after detecting many instances of snacking in a day as a reminder to Jane.

In some embodiments, computer system 600 detects potentially dangerous activities and notifies of such. In such embodiments, the potentially dangerous activities can be determined by the agent, such as the agent recognizing who is performing an activity and how that activity might be potentially dangerous to that person as opposed to others. For example, at FIG. 6C, in response to detecting that Jane is drinking smoothie 608, computer system 600 outputs first audio content 610 about smoothie 608 (e.g., including “You should make sure there is no banana in that smoothie”). In some embodiments, computer system 600 warns and interrupts Jane because it detected that Jane is performing potentially dangerous activities. For example, computer system 600 can warn Jane about the banana in smoothie 608 because computer system 600 identifies that Jane is severely allergic to bananas and that smoothies typically include bananas.

In some embodiments, computer system 600 identifies that Jane has a banana allergy because of a past occurrence, as indicated by the last part of first audio content 610 (e.g., “Last time you had banana you had an allergic reaction”). In some embodiments, computer system 600 identifies that Jane has a banana allergy in response to previously detecting an input from Jane such as, “Make sure I don't eat any bananas.” In some embodiments, computer system 600 identifies that Jane has a banana allergy because computer system 600 has heard Jane mention that she has a banana allergy. For example, computer system 600 overhears Jane mention to a friend, “I can't have banana because I am allergic.”

At FIG. 6C, first audio content 610 includes computer system 600 addressing Jane by name (e.g., “Hi Jane”) and identifies the action that Jane is performing (e.g., “I see that you are having a smoothie”). In some embodiments, first audio content 610 includes an identification of a previous interaction between Jane and computer system 600. For example, first audio content 610 includes “You told me to make sure you don't consume anything with banana in it.” In some embodiments, as part of outputting first audio content 610, computer system 600 moves one or more movement components of computer system 600. For example, computer system 600 can move back and forth to simulate shaking a head “no.” For another example, computer system 600 can move to face Jane as computer system 600 outputs first audio content 610.

As part of outputting first audio content 610, computer system 600 displays agent representation 604 as a square in the middle portion of agent user interface 602, as illustrated in FIG. 6A. In some embodiments, if computer system 600 displays agent representation 604 as a face, computer system 600 makes it appear as if agent representation 604 is talking by moving the mouth of agent representation 604. For example, computer system 600 can display the eyes, eyebrows, and/or mouth of agent representation 604 as moving in accordance with the audio output of first audio content 610 in such a way that it appears as if the audio output is coming from agent representation 604. In such an example, computer system 600 can sync movement of the mouth of agent representation 604 with the audio output of first audio content 610.

As illustrated in FIG. 6C, computer system 600 continues display of monitoring indicator 602c on agent user interface 602, which indicates that computer system 600 continues to monitor Jane's snacking habits. Also illustrated in FIG. 6C, computer system 600 displays restriction indicator 602d, which is illustrated as a crossed-out banana. Restriction indicator 602d is a visual element that corresponds to first audio content 610. Specifically, first audio content 610 indicates that Jane is allergic to banana and should make sure that smoothie 608 does not include banana and restriction indicator 602d represents that Jane should not consume banana. It should be recognized that restriction indicator 602d can have a different appearance and/or not be displayed in other embodiments.

In some embodiments, computer system 600 warns Jane about other potentially dangerous or harmful activities. For example, Jane can be allergic to peanuts and computer system 600 can detect that Jane is eating a cookie. In such an example, computer system 600 can interrupt Jane with an audio alert that she is allergic to peanuts before she grabs a cookie as a reminder. For another example, computer system 600 can identify that Jane is taking a medication that has adverse effects when Jane eats a grapefruit. In such an example, computer system 600 can output an audio alert about the danger when detecting Jane about to eat a grapefruit.

In some embodiments, computer system 600 does not interrupt Jane for activities that computer system 600 does not detect are harmful or dangerous. For example, computer system 600 would not warn Jane about the banana allergy if she was eating a burrito which typically does not include bananas. For another example, computer system 600 can identify that Jane is allergic to peanuts, but if computer system 600 identifies that a cookie does not include peanuts, computer system 600 might not warn Jane about her allergy as she reaches for the cookie. In this example, computer system 600 can identify that the cookie does not include peanuts by recognizing an ingredient list on a package for the cookie or recalling ingredients added to the cookie if it was baked near computer system 600. In some embodiments, computer system 600 only outputs warnings for the subject corresponding to the ongoing snack watch. For example, if computer system 600 detects Jane eating peanuts while performing a snack watch for a different subject that is not allergic to peanuts, computer system 600 does not output a warning to Jane. In such an example, the different subject is the one that performs an input such as input 605a, as discussed above.

FIG. 6D illustrates a time after FIG. 6C, as indicated by time indicator 602a (e.g., 12:05). At illustrated on the left side of FIG. 6D, computer system 600 displays agent representation 604 as a square in the middle portion of agent user interface 602. As illustrated on the right side of FIG. 6D, Jane is standing near computer system 600. At FIG. 6D, Jane says statement 612, “My blood sugar has been high lately.” It should be noted that statement 612 is not an input directed to computer system 600. Rather, statement 606 is a statement that computer system 600 overhears Jane saying to herself or to another person (e.g., a person within Jane's environment or a person that Jane is speaking with on the phone). In other embodiments, statement 612 is an input that Jane is directing to computer system 600. For example, Jane directs statement 612 to computer system 600 to request blood sugar monitoring, similar to as described with respect to input 605a.

At FIG. 6E, in response to detecting statement 612, computer system 600 outputs second audio content 614. Second audio content 614 is computer system 600 offering to monitor Jane's consumption to ensure that she does not consume anything that will spike her blood sugar. For example, second audio content 614 includes, “I can help monitor your food to prevent your blood sugar from rising too high”. At FIG. 6E, after outputting second audio content 614, computer system 600 detects input 605e. Input 605e is illustrated as a verbal input in which Jane gives consent for computer system 600 to monitor her consumption as it relates to blood sugar levels (e.g., Jane replies with “Thanks, that sounds good.”). It should be recognized that one or more other input types can be used. For example, after outputting second audio content 614, computer system 600 can detect Jane nodding her head to signify “yes.”

As part of outputting second audio content 614, computer system 600 displays agent representation 604 as a square in the middle portion of agent user interface 602, as illustrated in FIG. 6A. In some embodiments, if computer system 600 displays agent representation 604 as a face, computer system 600 makes it appear as if agent representation 604 is talking by moving the mouth of agent representation 604. For example, computer system 600 can display the eyes, eyebrows, and/or mouth of agent representation 604 as moving in accordance with the audio output of second audio content 614 in such a way that it appears as if the audio output is coming from agent representation 604. In such an example, computer system 600 syncs movement of the mouth of agent representation 604 with the audio output of second audio content 614.

At FIG. 6E, in response to detecting input 605e, computer system 600 begins a process of monitoring Jane's consumption as it relates to blood sugar levels. As part of monitoring Jane's consumption as it relates to blood sugar levels, computer system 600 displays blood sugar indicator 602e. In some embodiments, blood sugar indicator 602e is an indication of keywords (e.g., “Blood Sugar”) that computer system 600 determines are a focal point of statement 612 at FIG. 6D. In other embodiments, blood sugar indicator 602e is an indication that the agent has determined to monitor Jane's blood sugar.

FIG. 6F illustrates a time after FIG. 6E, as indicated by time indicator 602a (e.g., 3:00). As illustrated on the right side of FIG. 6F, Jane is standing near computer system 600 eating first apple 616. As illustrated on the left side of FIG. 6F, computer system 600 displays agent representation 604 as a triangle pointing in the direction of Jane to indicate that the attention of agent representation 604 is directed toward (e.g., computer system 600 is “watching”) Jane eating first apple 616. In some embodiments, at a time between FIG. 6E and FIG. 6F, computer system 600 displays agent representation 604 as a square, as illustrated in FIG. 6A, and, in response to detecting Jane eating first apple 616, computer system 600 displays agent representation 604 as a triangle. In such embodiments, computer system 600 displays agent representation 604 as a square when in a resting state and/or when no activity is detected and agent representation 604 as a triangle in response to detecting activity or when directing at something displayed or in the physical environment. In some embodiments, the attention of agent representation 604 is directed toward Jane the whole time that Jane is within the field of view of the one or more cameras of computer system 600. In other embodiments, the attention of agent representation 604 is directed toward Jane for a certain period of time before computer system 600 displays agent representation 604 as not directed toward Jane. Also illustrated in FIG. 6F, computer system displays agent user interface 602 as including snacking indicator 602b (e.g., “Snack Watch”) to indicate that computer system 600 is actively monitoring the snacking habits of Jane, per the request included in input 605a.

FIG. 6G illustrates a time 30 minutes after FIG. 6F, as indicated by time indicator 602 a (e.g., 3:30). At FIG. 6G, computer system 600 detects Jane walk by holding second apple 618. Although Jane is merely walking by computer system 600 while holding second apple 618 and not actively eating second apple 618, computer system 600 makes a determination that Jane will eat second apple 618. As such, computer system 600 notes a snacking activity. As illustrated in FIG. 6G, computer system 600 continues display of agent representation 604 as a triangle pointing toward Jane as well as monitoring indicator 602c. In addition, at FIG. 6G, computer system 600 continues display of monitoring indicator 602c in response to detecting Jane holding second apple 618.

At FIG. 6H, in response to detecting Jane walk by while holding second apple 618 within a certain time period after eating first apple 616 (e.g., 30 minutes as illustrated by FIGS. 6F-6G), computer system 600 infers that Jane is going to eat second apple 618. At FIG. 6H, computer system 600 makes a determination that two apples within such a time period can cause Jane's blood sugar to spike. In response to such an inference and determination, computer system 600 outputs third audio content 620. Third audio content 620 is a warning to Jane that she shouldn't have the second apple because it will make her blood sugar spike (e.g., computer system 600 outputs “You probably shouldn't have that second apple because it will make your blood sugar spike.”). As computer system 600 outputs third audio content 620, computer system 600 displays agent representation 604 as a square in the middle portion of agent user interface 602. In some embodiments, computer system 600 displays agent representation 604 as speaking (e.g., mouth moving), as described above, while computer system 600 outputs third audio content 620. In some embodiments, instead of second apple 618, Jane is carrying a different food item. In some embodiments, computer system 600 detects Jane carrying candy. In such an embodiment, computer system 600 still outputs third audio content 620 in response to determining that the candy would also spike Jane's blood sugar. In some embodiments, computer system 600 detects Jane carrying mail. In such an embodiment, computer system 600 forgoes output of third audio content 620 in response to detecting Jane carrying mail because carrying the mail

FIG. 6I illustrates a time after FIG. 6H, as indicated by time indicator 602a (e.g., 11:00). As illustrated on the right side of FIG. 6I, Jane is standing near computer system 600 while taking medication 622. As illustrated on the left side of FIG. 6I, computer system 600 displays agent representation 604 as a triangle pointing in the direction of Jane to indicate that the attention of agent representation 604 is directed toward (e.g., computer system 600 is “watching”) Jane take medication 622. In some embodiments, at a time between FIG. 6H and FIG. 6I, computer system 600 displays agent representation 604 as a square, as illustrated in FIG. 6A, and, in response to detecting Jane taking medication 622, computer system 600 displays agent representation 604 as a triangle. In some embodiments, the attention of agent representation 604 is not directed towards Jane. In such embodiments, computer system 600 identifies that Jane is taking medication 622 even without detecting Jane taking medication 622 (e.g., via the one or more cameras). For example, computer system 600 identifies that Jane takes medication 622 every day at the same time.

In some embodiments, computer system 600 identifies that Jane takes medication 622 every day at the same time in response to detecting Jane taking medication 622 every day at the same time for a certain period of time (e.g., for 30 consecutive days). In such embodiments, after the 30 days, computer system 600 assumes that Jane taking medication 622 at the same time every day is a pattern. In other embodiments, computer system 600 identifies that Jane takes medication 622 every day at the same time in response to detecting Jane telling computer system 600 her medication habits. For example, Jane tells computer system 600, “Make sure I take my medication every day at 11:00.”

FIG. 6J illustrates a time after and on the same day as FIG. 6I, as indicated by time indicator 602 a (e.g., 1:43). At FIG. 6J, computer system 600 detects Jane pouring grapefruit juice 626. At FIG. 6J, even though computer system 600 has not detected Jane drinking grapefruit juice 626, computer system 600 infers that she will. In response to this inference, computer system 600 outputs fourth audio content 628 (e.g., including “You shouldn't drink that grapefruit juice because it interacts with your medication”). In some embodiments, computer system 600 identifies that grapefruit juice 626 and medication 622 interact because Jane previously informed computer system 600 that grapefruit juice 626 and medication 622 interact. In some embodiments, computer system 600 identifies that grapefruit juice 626 and medication 622 interact because computer system 600 overheard Jane mentioning that grapefruit juice 626 and medication 622 interact. In some embodiments, computer system 600 identifies that grapefruit juice 626 and medication 622 interact from an internet source and/or a database. In some embodiments, computer system 600 identifies that grapefruit juice 626 and medication 622 interact because Jane entered the interaction information on a separate device, such as a personal device of Jane that is in communication with computer system 600.

As part of outputting fourth audio content 628, computer system 600 displays agent representation 604 as a square in the middle portion of agent user interface 602, as illustrated in FIG. 6A. In some embodiments, if computer system 600 displays agent representation 604 as a face, computer system 600 makes it appear as if agent representation 604 is talking by moving the mouth of agent representation 604. For example, computer system 600 displays the eyes, eyebrows, and/or mouth of agent representation 604 as moving in accordance with the audio output of fourth audio content 628 in such a way that it appears as if the audio output is coming from agent representation 604. In such an example, computer system 600 syncs movement of the mouth of agent representation 604 with the audio output of fourth audio content 628.

In some embodiments, computer system 600 outputs a warning similar to fourth audio content 628 in response to detecting Jane request a recipe that includes grapefruit. In such embodiments, computer system 600 infers that Jane will make the recipe and therefore warns Jane not to make the recipe and/or not to consume it due to the interaction between grapefruit and medication 622.

FIG. 6K illustrates a time exactly one week after (e.g., note that time indicator 602a is the same time at FIG. 6K as at FIG. 6A) computer system 600 began tracking Jane's snacking habits in response to detecting input 605a. In response to detecting that one week has passed (and/or that Jane is in front of or interacting with computer system 600), computer system 600 displays summary user interface 630. Summary user interface 630 includes summary 632, which is a summary of Jane's snacking habits that computer system 600 has tracked over the course of the preceding week. As indicated by title indicator 632a (e.g., “Snack Watch”), summary 632 is a description of the snacking habits of Jane. Specifically, summary 632 includes average snack indicator 632b, which is the average number of snacks that Jane ate per day. At FIG. 6K, average snack indicator 632b indicates that Jane ate an average of three snacks per day over the course of the preceding week. Summary 632 also includes average time indicator 632c, which is the average time of day that Jane ate snacks. At FIG. 6K, average time indicator 632c indicates that Jane snacked most often between 3:00 and 4:00 PM over the course of the preceding week.

Also illustrated in FIG. 6K, computer system 600 displays article 634 at a location corresponding to the bottom right corner of summary user interface 630. In some embodiments, in response to detecting an input on article 634, computer system 600 opens and displays a full screen view of article 634. Also illustrated in FIG. 6K, computer system 600 displays a minimized agent representation 604 at a location corresponding to the bottom left corner of summary user interface 630.

At FIG. 6K, computer system 600 outputs fifth audio content 636 informing Jane that computer system 600 is displaying summary 632. For example, fifth audio content 636 includes “This is your snacking summary after one week.” Fifth audio content 636 includes elements that are not included within summary 632. For example, fifth audio content 636 includes “I noticed that you snack most in between lunch and dinner,” which correlates to average time indicator 632c. For another example, fifth audio content 636 includes advice, such as “If you eat more carbs, you may snack less between meals.” Fifth audio content 636 also includes an indication that article 634 is a health article that includes tips. For example, fifth audio content 636 includes “Here is an article with some helpful tips.”

As part of outputting fifth audio content 636, computer system 600 displays agent representation 604 as a square in the middle portion of agent user interface 602, as illustrated in FIG. 6A. In some embodiments, if computer system 600 displays agent representation 604 as a face, computer system 600 makes it appear as if agent representation 604 is talking by moving the mouth of agent representation 604. For example, computer system 600 displays the eyes, eyebrows, and/or mouth of agent representation 604 as moving in accordance with the audio output of fifth audio content 636 in such a way that it appears as if the audio output is coming from agent representation 604. In such an example, computer system 600 syncs movement of the mouth of agent representation 604 with the audio output of fifth audio content 636.

In some embodiments, computer system 600 displays summary user interface 630 in response to detecting Jane requesting to see a summary of her snacking habits (e.g., even if one week has not yet elapsed). In some embodiments, computer system 600 displays summary user interface 630 at a time that computer system 600 detects Jane within a threshold distance to computer system 600. In some embodiments, computer system 600 displays summary user interface 630 in response detecting Jane perform the same action more than a threshold number of times. For example, in response to detecting Jane snacking more than a threshold number of times, computer system 600 displays summary user interface 630. In such an example, the threshold number of times is automatically set or is set in input 605a. In some embodiments, computer system 600 includes a picture of one or more instances of snacking within summary user interface 630.

In some embodiments, computer system 600 detects the action included in input 605a below a threshold number of times. For example, computer system 600 does not detect Jane snacking at all or detects Jane snacking very infrequently. In some embodiments, in response to detecting an input to display a different user interface (e.g., a verbal input such as, “Open the diet application”), computer system 600 ceases display of summary user interface 630 and displays the different user interface including a minimized version of summary 632. In such embodiments, computer system 600 maintains display of summary 632 so that Jane can simultaneously view the information included within summary 632 as well as a different user interface. For example, if the different user interface that computer system 600 opens corresponds to a diet application, Jane can view the information included in summary 632 while entering the information in the diet application. In some embodiments, computer system 600 displays summary 632 on the different user interface in response to detecting a request from Jane. For example, if computer system 600 detects an input such as “Show me my one-week snacking summary” while displaying a user interface corresponding to a health application, computer system 600 displays summary 632 on the health application user interface. In some embodiments, computer system 600 displays summary 632 on a different user interface in response to detecting an input on an icon related to the summary. In some embodiments, summary 632 is available on a secondary device. For example, Jane can access summary 632 within a health application on a personal device of Jane that is in communication with computer system 600.

In some embodiments, computer system 600 outputs summaries of Jane's snacking behavior periodically during the one-week time requested by Jane. For example, computer system 600 outputs a summary during each instance of snacking. In this example, the summary at each instance of snacking may include the number of snacks that day, what snacking activity computer system 600 is currently recording, and/or indicate if the snack is healthy (e.g., “An apple is healthy but is still a snack”).

FIG. 7 is a flow diagram illustrating a process (e.g., process 700) for interrupting user activities in accordance with some embodiments. Some operations in process 700 are, optionally, combined, the orders of some operations are, optionally, changed, and some operations are, optionally, omitted.

As described below, process 700 provides an intuitive way for interrupting user activities in accordance with some embodiments. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., 600) that is in communication (e.g., wired communication and/or wireless communication) with (and/or includes) one or more input devices (e.g., a camera, a depth sensor, a microphone, a hardware input mechanism, a rotatable input mechanism, a heart monitor, a temperature sensor, and/or a touch-sensitive surface) and one or more output devices (e.g., a display component, an audio component, and/or a haptic component). In some embodiments, the computer system is a phone, a watch, a tablet, a fitness tracking device, a wearable device, an accessory, a speaker, a light, a head-mounted display (HMD), and/or a personal computing device.

The computer system detects (702), via the one or more input devices, an activity (e.g., such as described above with respect to FIGS. 6B and 6F-6J) (e.g., action and/or operation) of a subject (e.g., 606) (e.g., a user, a person, an animal, another computer system different from the computer system, a device, and/or an object). In some embodiments, the activity includes a set of one or more activities and/or a set of repeated activities of the subject.

In response to (704) detecting the activity of the subject, in accordance with a determination that the activity satisfies a set of one or more criteria (e.g., activity risks safety of the subject and/or activity harms health of the subject), the computer system outputs (706), via the one or more output devices, an indication (e.g., 610, 620, 628, and such as described above with respect to FIG. 6C) (e.g., audio content, visual content, movement content, and/or haptic content) to interrupt the activity. In some embodiments, the computer system is in communication with one or more movement components (e.g., an actuator, a movable base, a rotatable component, a motor, a lift, a level, and/or a rotatable base). In some embodiments, movement content includes the computer system moves (e.g., rotates and/or articulates), via the one or more movement components, a portion of the computer system. In some embodiments, the indication to interrupt the activity includes content corresponding to an interruption (e.g., a request to stop and/or warning) of the activity. In some embodiments, the indication to interrupt the activity includes a request to change the performance of the activity.

In response to (704) detecting the activity of the subject, in accordance with a determination that the activity does not satisfy the set of one or more criteria, the computer system forgoes (708) output of, via the one or more output devices, the indication to interrupt the activity (e.g., such as described above with respect to FIG. 6C). Performing an operation when a set of conditions has been met without requiring further user input (such as by selectively outputting an interruption of an activity (and/or an inferred activity) in response to a danger or a request to monitor) enhances the operability of the device by reducing unnecessary inputs and/or steps to navigate through different user interfaces or sets of controls, reducing energy usage by the device. Providing additional control options without cluttering the UI with additional displayed controls (such as by selectively outputting an interruption of an activity (and/or an inferred activity) in response to danger or a request to monitor) enhances the operability of the device by reducing unnecessary inputs and/or steps to navigate through different user interfaces or sets of controls, reducing energy usage by the device.

In some embodiments, the set of one or more criteria includes a criterion that is satisfied when the activity of the subject is dangerous to the subject (such as described above with respect to FIGS. 6C, 6H, and 6J) (e.g., the health and/or safety of the subject). In some embodiments, the computer system determines the activity of the subject is dangerous based on a previous interaction. In some embodiments, the previous interaction includes a request from the subject to monitor the activity. In some embodiments, the previous interaction includes a result of a previous activity. In some embodiments, the danger of the activity of the subject is based on a known profile of the subject.

In some embodiments, the activity of the subject is a first activity of the subject. In some embodiments, the set of one or more criteria includes a criterion that is satisfied when the first activity of the subject corresponds to (e.g., is the same as and/or include one or more similar characteristics as) a second activity (e.g., such as described above with respect to FIG. 6C) of the subject that had (e.g., caused or resulted in) a particular result (e.g., effect and/or outcome). In some embodiments, the second activity of the subject is separate from the first activity of the subject.

In some embodiments, the set of one or more criteria includes a criterion that is satisfied when a determination is made that the computer system previously detected, via the one or more input devices, an input (e.g., a tap input, a voice input, and/or an air gesture) corresponding to a request for the activity of the subject to be monitored (e.g., such as described above with respect to FIG. 6H) (e.g., tracked, reviewed, and/or watched). In some embodiments, the input is a tap input on a user interface element and/or a voice input requesting that an operation be performed (e.g., “Please monitor my snacking.”). In some embodiments, the respective input includes an air gesture of a hand wave and/or pointing in a direction (e.g., pointing at a snack on a table) corresponding to the software agent and/or not corresponding to the software agent.

In some embodiments, the set of one or more criteria includes a criterion that is satisfied when a determination is made that the computer system previously detected, via the one or more input devices, one or more characteristics (e.g., allergy to peanuts, diabetic, and/or lactose intolerance) of the subject. In some embodiments, the one or more characteristics correspond to (e.g., directed to, related to, and/or associated with) the activity of the subject (e.g., such as described above with respect to FIGS. 6C, 6E, 6H, 6J). In some embodiments, detecting the one or more characteristics of the subject include detecting, via the one or more input devices, an input (e.g., a tap input, a voice input, and/or an air gesture) from the subject. In some embodiments, the input is a tap input on a user interface element to select an allergy of the subject. In some embodiments, the input is a voice input discussing an allergy of the subject (and/or directed to the computer system or not directed to the computer system).

In some embodiments, the activity of the subject is a first activity of the subject. In some embodiments, after forgoing output of the indication to interrupt the activity, the computer system detects, via the one or more input devices, a second activity (e.g., action and/or operation) of the subject separate from the first activity of the subject (e.g., such as described above with respect to FIG. 6G). In some embodiments, the second activity includes a set of one or more activities and/or a set of repeated activities of the subject. In some embodiments, in response to detecting the second activity of the subject, the computer system outputs, via the one or more output devices, the indication to interrupt the activity (e.g., such as described above with respect to FIG. 6H).

In some embodiments, the second activity of the subject is different from the first activity of the subject (e.g., such as described above with respect to FIG. 6G). In some embodiments, the second activity of the subject is a different type (e.g., eating, bad posture, and/or doing homework) of activity from the first activity of the subject.

In some embodiments, the second activity of the subject is the same as (e.g., a repeated taking of medication, eating multiple sugary foods, and/or maintaining poor posture) the first activity of the subject (e.g., such as described above with respect to FIG. 6G). In some embodiments, the second activity of the subject is detected within a threshold amount of time (e.g., 1 second to 1 hour) of the first activity of the subject.

In some embodiments, the computer system is in communication with (and/or includes) one or more display components (e.g., a display screen, a projector, a head mounted display, and/or a touch-sensitive display). In some embodiments, the one or more output devices include the one or more display components. In some embodiments, while detecting the activity of the subject, the computer system displays, via the one or more display generation components, a representation (e.g., 604) (e.g., a textual representation, a graphical representation, and/or an animation) of a software agent (e.g., a virtual assistant, a computer program, an intelligence model, and/or an artificial intelligence program, such as described above with respect to FIG. 5). In some embodiments, the representation of the software agent is a face and the first manner is a first expression. In some embodiments, while outputting the indication to interrupt the activity, the computer system maintains display of, via the one or more display generation components, the representation of the software agent (e.g., such as described above with respect to FIGS. 6B and 6F-6J).

In some embodiments, while detecting the activity of the subject, the representation of the software agent is displayed in a first manner (e.g., color, orientation, and/or arrangement) (e.g., such as described above with respect to FIGS. 6B, 6F-6G, and/or 6I). In some embodiments, while outputting the indication to interrupt the activity, the representation of the software agent is displayed in a second manner (e.g., such as described above with respect to FIGS. 6B and 6F-6J) (e.g., color, orientation, and/or arrangement) different from the first manner (and/or is no longer displayed in the first manner).

In some embodiments, the second manner includes a representation (e.g., a textual representation, a graphical representation, and/or an animation) of the software agent speaking (e.g., such as described above with respect to FIG. 6H).

In some embodiments, the indication to interrupt the activity includes audio output (e.g., such as described above with respect to FIGS. 6C-6D, 6H, and/or 6K) (e.g., a beep, a tone, one or more words, music, and/or an alert sound). In some embodiments, the audio output identifies the subject, the activity, and/or a previous request (e.g., “Your medication interacts with grapefruit juice).

In some embodiments, the computer system is in communication with (and/or includes) one or more movement components (e.g., an actuator, a movable base, a rotatable component, a motor, a lift, a level, and/or a rotatable base). In some embodiments, outputting the indication to interrupt the activity includes moving, via the one or more movement components, a portion (e.g., that includes at least one of the one or more input devices and/or at least one of the one or more input devices) of the computer system in a third manner (e.g., such as described above with respect to FIGS. 6B and 6C) (e.g., shaking the computer system as if a head shake and/or moving back and forth as if dancing).

In some embodiments, the computer system is in communication with (and/or includes) one or more display components (e.g., a display screen, a projector, a head mounted display, and/or a touch-sensitive display). In some embodiments, outputting the indication to interrupt the activity includes displaying, via the one or more display components, visual output (e.g., 602d) (e.g., a video, an image, an animation, a 3D rendering, an augmented reality overlay, a motion graphic, a data visualization, and/or a digital art). In some embodiments, the visual output includes content identifying the subject, indicating the activity, and/or indicating a previous request.

In some embodiments, the indication to interrupt the activity includes an identification of the activity (e.g., 610, 620, 628, and/or such as described above with respect to FIG. 6C).

In some embodiments, the indication to interrupt the activity includes an identification (e.g., “Jane” in 610 and/or 628) (e.g., name and/or image) of the subject.

In some embodiments, the indication to interrupt the activity includes an identification of a previous interaction (e.g., such as described above with respect to 626 and FIG. 6K) with the computer system. In some embodiments, the previous interaction includes a request from the subject to monitor the activity.

In some embodiments, the indication to interrupt the activity includes an identification of a previous result (e.g., such as described above with respect to 610 and 620) of previously performing the activity. In some embodiments, the previous result was detected by the computer system detects via the one or more input devices.

In some embodiments, the computer system is in communication with (and/or includes) one or more display components (e.g., a display screen, a projector, a head mounted display, and/or a touch-sensitive display), further comprising: while detecting the activity of the subject, displaying, via the one or more display components, an indication (e.g., 602b, 602c, and/or 602e) of the activity.

In some embodiments, the computer system is in communication with (and/or includes) one or more movement components (e.g., an actuator, a movable base, a rotatable component, a motor, a lift, a level, and/or a rotatable base). In some embodiments, while detecting the activity of the subject, the computer system detects via the one or more input devices, the subject move from a first position (e.g., orientation, location, and/or coordinate) to a second position (e.g., orientation, location, and/or coordinate) different from the first position. In some embodiments, in response to detecting the subject move from the first position to the second position and while detecting the activity of the subject, the computer system moves, via the one or more movement components, a portion (e.g., that includes one or more input devices and/or one or more output devices of the computer system) of the computer system from a third position (e.g., orientation, location, and/or coordinate) to a fourth position (e.g., orientation, location, and/or coordinate) different from the third position (e.g., such as described above with respect to FIG. 6B). In some embodiments, the third position enables the computer system to capture the subject at the second position.

In some embodiments, the computer system is in communication with (and/or includes) one or more movement components (e.g., an actuator, a movable base, a rotatable component, a motor, a lift, a level, and/or a rotatable base). In some embodiments, in conjunction with (e.g., before, and/or while) outputting the indication to interrupt the activity, the computer system moves, via the one or more movement components, a portion (e.g., that includes one or more input devices and/or one or more output devices of the computer system) of the computer system so that the portion of the computer system faces the subject (e.g., such as described above with respect to FIG. 6C).

In some embodiments, the activity is a first activity. In some embodiments, after forgoing output of the indication to interrupt the activity, the computer system detects, via the one or more input devices, a second activity (e.g., such as described above with respect to FIGS. 6G-6H) (e.g., an action and/or operation) of the subject, wherein the second activity of the subject is different from the first activity of the subject. In some embodiments, the second activity includes a set of one or more activities and/or a set of repeated activities of the subject. In some embodiments, in response to detecting the second activity of the subject, in accordance with a determination that the second activity corresponds to (e.g., is inferred to be, is determined to be, and/or is) a third activity (e.g., an action and/or operation) that satisfies the set of one or more criteria, the computer system outputs, via the one or more output devices, an indication (e.g., 620) (e.g., audio content, visual content, movement content, and/or haptic content) to interrupt the third activity (e.g., and not the second activity), wherein the third activity is separate from the second activity. In some embodiments, the third activity is different from the second activity. In some embodiments, the third activity is the same as the second activity. In some embodiments, the third activity includes a set of one or more activities and/or a set of repeated activities of the subject. In some embodiments, the computer system is in communication with one or more movement components (e.g., an actuator, a movable base, a rotatable component, a motor, a lift, a level, and/or a rotatable base). In some embodiments, movement content includes the computer system moves (e.g., rotates and/or articulates), via the one or more movement components, a portion of the computer system. In some embodiments, the indication to interrupt the third activity includes content corresponding to an interruption (e.g., a request to stop and/or warning) of the third activity. In some embodiments, the indication to interrupt the third activity includes a request to change the performance of the third activity. In some embodiments, the indication to interrupt the third activity is the same as the indication to interrupt the first activity. In some embodiments, the indication to interrupt the third activity is different from the indication to interrupt the activity. In some embodiments, in response to detecting the second activity of the subject, in accordance with a determination that the second activity does not satisfy the set of one or more criteria and that the second activity does not correspond to an activity (e.g., the third activity and/or an activity different from the second activity) that satisfies the set of one or more criteria, the computer system forgoes output of, via the one or more output devices, the indication to interrupt the third activity (e.g., such as described above with respect to FIG. 6H).

Note that details of the processes described above with respect to process 700 (e.g., FIG. 7) are also applicable in an analogous manner to other processes described herein. For example, process 800 optionally includes one or more of the characteristics of the various processes described above with reference to process 700. For example, the summary of the activity performed for process 800 can occur in response to the activity of the subject of process 700. For brevity, these details are not repeated herein.

FIG. 8 is a flow diagram illustrating a process (e.g., process 800) for summarizing user activities in accordance with some embodiments. Some operations in process 800 are, optionally, combined, the orders of some operations are, optionally, changed, and some operations are, optionally, omitted.

As described below, process 800 provides an intuitive way for summarizing user activities in accordance with some embodiments. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system (e.g., 600) that is in communication (e.g., wired communication and/or wireless communication) with (and/or includes) one or more input devices (e.g., a camera, a depth sensor, a microphone, a hardware input mechanism, a rotatable input mechanism, a heart monitor, a temperature sensor, and/or a touch-sensitive surface) and one or more output devices (e.g., a display component, an audio component, and/or a haptic component). In some embodiments, the computer system is a phone, a watch, a tablet, a fitness tracking device, a wearable device, an accessory, a speaker, a light, a head-mounted display (HMD), and/or a personal computing device.

The computer system detects (802), via the one or more input devices, an input (e.g., 605a) (e.g., a voice input and/or tap input) corresponding to (e.g., associated with, including an indication and/or an identification of, and/or identifying) an instruction (e.g., an instruction for monitoring an activity and/or an instruction to output a summary of an activity, such as an activity performed over time).

After detecting the input corresponding to the instruction, the computer system detects (804), via the one or more input devices, that a subject (e.g., 606) (e.g., a user, a person, an animal, another computer system different from the computer system, a device, and/or an object) performed an activity (e.g., such as described above with respect to FIGS. 6B and 6F-6H) (e.g., action and/or operation). In some embodiments, the activity includes a set of one or more activities and/or a set of repeated activities of the subject.

After (806) (and/or in response to) detecting that the subject performed the activity, in accordance with a determination that the activity corresponds to the instruction, the computer system outputs (808), via the one or more output devices, content (e.g., 632 and/or 636) (e.g., audio content and/or visual content) corresponding to (and/or including) a summary (e.g., activity log, highlights, and/or overview) of the activity performed. In some embodiments, the summary of the activity performed is a summary of one or more times that the activity was performed, such as a summary of one nor more times that the activity was performed over a predefined and/or predetermined period of time (e.g., 1 day to 1 month).

After (806) detecting that the subject performed the activity, in accordance with a determination that the activity does not correspond to the instruction, the computer system forgoes (810) output of, via the one or more output devices, the content corresponding to the summary of the activity performed (e.g., such as described above with respect to FIG. 6K). Performing an operation when a set of conditions has been met without requiring further user input (such as by selectively outputting a summary of an activity (and/or an inferred activity) in response to a danger or a request to monitor) enhances the operability of the device by reducing unnecessary inputs and/or steps to navigate through different user interfaces or sets of controls, reducing energy usage by the device. Providing additional control options without cluttering the UI with additional displayed controls such as by selectively outputting a summary of an activity (and/or an inferred activity) in response to a danger or a request to monitor) enhances the operability of the device by reducing unnecessary inputs and/or steps to navigate through different user interfaces or sets of controls, reducing energy usage by the device.

In some embodiments, the one or more output devices includes one or more display components (e.g., a display screen, a projector, a head mounted display, and/or a touch-sensitive display). In some embodiments, outputting the content corresponding to the summary of the activity performed includes displaying, via the one or more display generation components, visual content (e.g., 632, 632a, 632b, and/or 632c) (e.g., a video, an image, text, an animation, a 3D rendering, an augmented reality overlay, a motion graphic, a data visualization, and/or a digital art). In some embodiments, the visual content includes content identifying the subject, indicating the activity, indicating when the activity occurs (and/or when the activity typically occurs), and/or indicating a previous request.

In some embodiments, the one or more output devices includes one or more audio components (e.g., a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output). In some embodiments, outputting the content corresponding to the summary of the activity performed includes outputting, via the one or more audio contents, audio content (e.g., 636) (e.g., a beep, a tone, one or more words, music, and/or an alert sound). In some embodiments, the audio content includes content identifying the subject, indicating the activity, indicating when the activity occurs and/or when the activity typically occurs (e.g., you have been snacking mostly after dinner, and/or you have forgotten to take your medication three times this week), and/or indicating a previous request.

In some embodiments, the content corresponding to the summary of the activity performed includes a description of data (e.g., such as described above with respect to FIG. 6K) corresponding to (e.g., detected, such as via the one or more input devices) the activity performed (and/or without directly indicating the activity itself).

In some embodiments, after (and/or in response to) detecting that the subject performed the activity and in accordance with the determination that the activity corresponds to the instruction, the computer system outputs, via the one or more output devices, content corresponding to (and/or including an indication of) a recommended (e.g., suggested and/or proposed) operation (e.g., 634, “eat more carbs,” such as described above with respect to FIG. 6K) (e.g., action, habit, and/or movement), wherein the recommended action corresponds to the activity performed. In some embodiments, the recommended action is to prevent the activity performed (e.g., “if you eat more carbs you may snack less between meals, here are some healthy options” and/or “stop, the grapefruit juice interacts with your medication”).

In some embodiments, the instruction is a first instruction. In some embodiments, the activity is a first activity. In some embodiments, after forgoing output of the content corresponding to the summary of the activity performed (or after outputting the content corresponding to the summary of the activity performed), the computer system detects, via the one or more input devices, an input (e.g., a voice input and/or tap input) corresponding to (e.g., associated with, including an indication and/or an identification of, and/or identifying) a second instruction (e.g., an instruction for monitoring an activity and/or an instruction to output a summary of an activity, such as an activity performed over time). In some embodiments, the second instruction is different from the first instruction. In some embodiments, the second instruction is the same as the first instruction. In some embodiments, after detecting the input corresponding to the second instruction, the computer system detects, via the one or more input devices, that the subject performed a second activity (e.g., such as described above with respect to FIG. 6K) (e.g., action and/or operation). In some embodiments, the second activity includes a set of one or more activities and/or a set of repeated activities of the subject. In some embodiments, the second activity is different from the first activity. In some embodiments, the second activity is the same as the first activity. In some embodiments, after (and/or in response to) detecting that the subject performed the second activity, in accordance with a determination that a first set of one or more criteria (e.g., the first activity and the second activity correspond to the instruction, the second activity corresponds to the instruction, and/or the first activity and the second activity are within a threshold period of time) is satisfied, wherein the first set of one or more criteria includes a criterion that is satisfied when the second activity corresponds to the second instruction, the computer system outputs, via the one or more output devices, content (e.g., audio content and/or visual content) corresponding to (and/or including) a summary (e.g., 632 and/or 636) (e.g., activity log, highlights, and/or overview) of the second activity performed. In some embodiments, the second summary of the activity performed is a summary of one or more times that the activity was performed (e.g., the first activity and/or the second activity), such as a summary of one nor more times that the activity was performed over a predefined and/or predetermined period of time (e.g., 1 day to 1 month). In some embodiments, the second summary of the activity performed is different from the first summary of activity performed. In some embodiments, the second summary of the activity performed is the same as the first summary of the activity performed. In some embodiments, the threshold period of time is 10 minutes, one week, and/or one month. In some embodiments, after detecting that the subject performed the second activity, in accordance with a determination that a second set of one or more criteria is satisfied, wherein the second set of one or more criteria includes a criterion that is satisfied when the second activity corresponds to the second instruction, the computer system forgoes output of, via the one or more output devices, the content corresponding to the summary of the activity performed, wherein the second set of one or more criteria is different from the first set of one or more criteria.

In some embodiments, the first set of one or more criteria includes a criterion that is satisfied when the second activity is detected within a threshold period of time. In some embodiments, the second set of one or more criteria includes a criterion that is not satisfied when the second activity is not detected within the threshold period of time (e.g., one week, such as described above with respect to FIG. 6K). In some embodiments, the threshold period of time is 10 minutes, one week, and/or one month. In some embodiments, the threshold period of time is a differential in time between the second activity and the first activity, and/or the second activity and the second instruction. In some embodiments, the threshold period of time is automatically set. In some embodiments, an indication of the threshold period of time is included in the input corresponding to the second instruction (e.g., “monitor my snacking for one week”).

In some embodiments, the first set of one or more criteria includes a criterion that is satisfied when a number of instances (e.g., quantity and/or amount) of activities corresponding to the second instruction satisfies a quantity threshold. In some embodiments, the second set of one or more criteria includes a criterion that is not satisfied when the number of instances of activities corresponding to the second instruction does not satisfy the quantity threshold (e.g., threshold number of times, such as described above with respect to FIG. 6K). In some embodiments, the quantity threshold is two, three, and/or 10 instances of the activity. In some embodiments, the quantity threshold is automatically set. In some embodiments, an indication of the quantity threshold is included in the input corresponding to the second instruction (e.g., “monitor my snacking for one week”).

In some embodiments, the number of instances of activities corresponding to the second instruction satisfies the quantity threshold when the number of instances of activities corresponding to the second instruction is below the quantity threshold (e.g., such as described above with respect to FIG. 6K). In some embodiments, the number of instances of activities corresponding to the second instruction satisfies the quantity threshold when the number of instances of activities corresponding to the second instruction is above the quantity threshold.

In some embodiments, the computer system is in communication with (and/or includes) one or more display components (e.g., a display screen, a projector, a head mounted display, and/or a touch-sensitive display). In some embodiments, the one or more output devices include the one or more display components. In some embodiments, after (and/or while) outputting the content corresponding to the summary of the second activity performed, the computer system detects, via the one or more input devices, an input (e.g., “open diet application,” such as described above with respect to FIG. 6K) (e.g., a voice input and/or tap input) corresponding to (e.g., associated with, directed to, and/or related to) a request to display a user interface (e.g., a health application user interface, a home application user interface, and/or a checklist application user interface). In some embodiments, the user interface is a first user interface. In some embodiments, in accordance with the determination that the activity corresponds to the instruction, the computer system displays, via the one or more display generation components, a second user interface different from the first user interface, wherein the second user interface includes the content corresponding to the second summary of the activity performed. In some embodiments, in response detecting the input corresponding to the request to display the user interface, the computer system displays, via the one or more display components, the user interface including a representation (e.g., 632) (e.g., a graphical representation and/or a textual representation) of the content corresponding to (e.g., associated with, including an indication and/or an identification of, and/or identifying) the summary of the second activity performed.

In some embodiments, the determination that the activity corresponds to the instruction includes a determination that the same subject provided the instruction as who performed the activity (e.g., such as described above with respect to FIGS. 6A and 6K).

In some embodiments, the subject is a first subject. In some embodiments, the input corresponding to the instruction was detected as originating from a second subject. In some embodiments, the second subject is different from the first subject (e.g., such as described above with respect to FIG. 6K).

In some embodiments, before detecting the activity of the subject, the computer system outputs, via the one or more output devices, a suggestion of the instruction (e.g., “I can help you monitor your snacking” and/or “I can make sure you take your medication,” such as described above with respect to FIG. 6A), wherein the input corresponding to the instruction is an input corresponding to the suggestion of the instruction. In some embodiments, the suggestion is generated by an agent (e.g., as described above with respect to FIG. 5). In some embodiments, the suggestion is generated by the computer system on behalf of or for the subject.

In some embodiments, the computer system is in communication with (and/or includes) one or more display components (e.g., a display screen, a projector, a head mounted display, and/or a touch-sensitive display). In some embodiments, the one or more output devices include the one or more display components. In some embodiments, while detecting the subject perform the activity, the computer system displays, via the one or more display components, a representation (e.g., 604) (e.g., a textual representation, a graphical representation, and/or an animation) of a software agent (e.g., a virtual assistant, a computer program, an intelligence model, and/or an artificial intelligence program, such as described above with respect to FIG. 5). In some embodiments, the representation of the software agent is a face and the first manner is a first expression. In some embodiments, while outputting the content corresponding to the summary of the activity performed, the computer system maintains display of (and/or displays), via the one or more display generation components, the representation of the software agent (e.g., such as described above with respect to FIGS. 6B and 6F-6J).

In some embodiments, while detecting the subject performed the activity the representation of the software agent is displayed in a first manner (e.g., such as described above with respect to FIGS. 6B, 6F-6G, and/or 6I) (e.g., color, orientation, and/or arrangement). In some embodiments, while outputting the content corresponding to the summary of the activity performed, the representation of the software agent is displayed in a second manner (e.g., such as described above with respect to FIGS. 6B and 6F-6J) (e.g., color, orientation, and/or arrangement) different from the first manner (and/or is not displayed in the first manner).

In some embodiments, the second manner includes a representation (e.g., a textual representation, a graphical representation, and/or an animation) of the software agent speaking (e.g., such as described above with respect to FIG. 6H).

In some embodiments, the computer system is in communication with (and/or includes) one or more display components (e.g., a display screen, a projector, a head mounted display, and/or a touch-sensitive display). In some embodiments, the one or more output devices include the one or more display components. In some embodiments, while (and/or in response to) detecting the subject perform the activity, the computer system displays, via the one or more display components, an indication (e.g., 610, 620, 628, and such as described above with respect to FIG. 6C) (e.g., audio content, visual content, movement content, and/or haptic content) of the activity being performed by the subject. In some embodiments, the visual content includes a description of the activity being performed by the subject (e.g., “taking medication” and/or “snack watch”).

In some embodiments, the computer system is in communication with (and/or includes) one or more movement components (e.g., an actuator, a movable base, a rotatable component, a motor, a lift, a level, and/or a rotatable base). In some embodiments, while detecting the subject perform the activity, the computer system detects via the one or more input devices, the subject move from a first position (e.g., orientation, location, and/or coordinate) to a second position (e.g., orientation, location, and/or coordinate) different from the first position. In some embodiments, in response to detecting the subject move from the first position to the second position and while detecting the subject perform the activity, the computer system moves, via the one or more movement components, a portion (e.g., that includes one or more input devices and/or one or more output devices of the computer system) of the computer system from a third position (e.g., orientation, location, and/or coordinate) to a fourth position (e.g., orientation, location, and/or coordinate) (e.g., such as described above with respect to FIG. 6B). In some embodiments, the third position enables the computer system to capture the subject at the second position.

In some embodiments, the computer system is in communication with (and/or includes) one or more movement components (e.g., an actuator, a movable base, a rotatable component, a motor, a lift, a level, and/or a rotatable base). In some embodiments, in conjunction with (e.g., before, and/or while) outputting content corresponding to the summary of the activity performed, the computer system moves, via the one or more movement components, a portion (e.g., that includes one or more input devices and/or one or more output devices of the computer system) of the computer system so that the portion of the computer system faces the subject (e.g., such as described above with respect to FIG. 6C).

In some embodiments, the activity performed by the subject is a first activity performed by the subject. In some embodiments, after forgoing output of the content corresponding to the summary of the activity performed, the computer system detects, via the one or more input devices, that the subject performed a second activity (e.g., such as described above with respect to FIGS. 6G-6H) (e.g., an action and/or operation), wherein the second activity performed by the subject is different from the first activity performed by the subject. In some embodiments, the second activity includes a set of one or more activities and/or a set of repeated activities of the subject. In some embodiments, in response to detecting the second activity performed by the subject, in accordance with a determination that the second activity performed by the subject corresponds to (e.g., is inferred to be, is determined to be, and/or is) a third activity (e.g., an action and/or operation) that corresponds to the instruction, the computer system outputs, via the one or more output devices, second content (e.g., 620) (e.g., audio content and/or visual content) corresponding to a summary (e.g., activity log, highlights, and/or overview) of the third activity performed. In some embodiments, the third activity is different from the second activity. In some embodiments, the third activity is the same as the second activity. In some embodiments, the summary of the third activity performed is a summary of one or more times that the third activity was performed, such as a summary of one or more times that the third activity was performed over a predefined and/or predetermined period of time (e.g., 1 day to 1 month). In some embodiments, the summary of the third activity performed is different from the summary of the first activity performed. In some embodiments, the summary of the third activity performed is the same as the summary of the first activity performed. In some embodiments, in response to detecting the second activity performed by the subject, in accordance with a determination that the second activity does not correspond to the third activity and that the second activity does not correspond to the instruction, the computer system forgoes output of, via the one or more output devices, the second content corresponding to the summary of the third activity performed (e.g., such as described above with respect to FIG. 6H).

Note that details of the processes described above with respect to process 800 (e.g., FIG. 8) are also applicable in an analogous manner to the processes described herein. For example, process 700 optionally includes one or more of the characteristics of the various processes described herein with reference to process 800. For example, the indication to interrupt the activity of process 700 can be included in the content corresponding to the summary of the activity performed of process 800. For brevity, these details are not repeated herein.

The description above, has been described with reference to specific examples for the purpose of explanation. Such specific examples can be in the form of textual description above and/or in the accompanying drawings. However, such embodiments should not be interpreted as being exhaustive and/or limiting to the disclosure (e.g., limiting to the explicit manners described herein). Many modifications and variations are possible in view of the above teachings by one of ordinary skill in the art without departing from the scope of the present disclosure.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

Aspects of the technology described above can include gathering and/or using data from various sources. Such data can be used to improve interactions that a device has with its environment (e.g., interactions with users). In some scenarios, such data can include personal information that is usable to uniquely identify a specific person. Such personal information can include demographic data, telephone numbers, email addresses, location and/or location-related data, home addresses, work addresses, and/or any other identifying information. The use of such personal information can be utilized for the benefit of users of the device. For example, a user's personal information can be used to improve interactions that the device engages in with the user. Other benefits from the use for personal information data are also possible and within the scope of the present disclosure.

The use of personal information can require one or more entities handling such data. These entities can be involved in collecting, processing, disclosing, transferring, storing, or other functions that support the technologies described herein. The present disclosure expects that (e.g., does not preclude) that all use of personal information data complies with well-established privacy policies and/or privacy practices by such entities. As a general matter, such policies and practices should meet or exceed generally recognized industry standards and comply with all applicable data privacy and security-related governmental requirements. In particular, for example, entities should receive informed consent from users to collect and/or use such personal information, and such collection and/or use should only be for legitimate and reasonable uses. Further, personal information of a user should not be shared, disclosed, sold, and/or provided for uses other than legitimate and/or reasonable uses.

Various scenarios can arise in which personal information is not available, such as when a user selects not to share such information. For example, the user can withhold consent for collection and/or use of such data (e.g., “opt out” of sharing such data and/or not explicitly “opt in” during a registration process). The user can also employ the use of any of various hardware and/or software components that prevent collection and/or use of such data. While the use of personal information can benefit a user by improving the operation of the device, the present disclosure contemplates that embodiments of the present technology can be used without such data. For example, operations of the device can use non-personal information (e.g., instead of and/or in place of personal information). Other techniques include making inferences based on non-personal information data or a minimal amount of personal information.

What is claimed is:

1. A method, comprising:
at a computer system that is in communication with one or more input devices and one or more output devices:
detecting, via the one or more input devices, an activity of a subject; and
in response to detecting the activity of the subject:
in accordance with a determination that the activity satisfies a set of one or more criteria, outputting, via the one or more output devices, an indication to interrupt the activity; and
in accordance with a determination that the activity does not satisfy the set of one or more criteria, forgoing output of, via the one or more output devices, the indication to interrupt the activity.

2. The method of claim 1, wherein the set of one or more criteria includes a criterion that is satisfied when the activity of the subject is dangerous to the subject.

3. The method of claim 1, wherein the activity of the subject is a first activity of the subject, wherein the set of one or more criteria includes a criterion that is satisfied when the first activity of the subject corresponds to a second activity of the subject that had a particular result, and wherein the second activity of the subject is separate from the first activity of the subject.

4. The method of claim 1, wherein the set of one or more criteria includes a criterion that is satisfied when a determination is made that the computer system previously detected, via the one or more input devices, an input corresponding to a request for the activity of the subject to be monitored.

5. The method of claim 1, wherein the set of one or more criteria includes a criterion that is satisfied when a determination is made that the computer system previously detected, via the one or more input devices, one or more characteristics of the subject, and wherein the one or more characteristics correspond to the activity of the subject.

6. The method of claim 1, wherein the activity of the subject is a first activity of the subject, the method further comprising:
after forgoing output of the indication to interrupt the activity, detecting, via the one or more input devices, a second activity of the subject separate from the first activity of the subject; and
in response to detecting the second activity of the subject, outputting, via the one or more output devices, the indication to interrupt the activity.

7. The method of claim 6, wherein the second activity of the subject is different from the first activity of the subject.

8. The method of claim 6, wherein the second activity of the subject is the same as the first activity of the subject.

9. The method of claim 1, wherein the computer system is in communication with one or more display components, the method further comprising:
while detecting the activity of the subject, displaying, via the one or more display generation components, a representation of a software agent; and
while outputting the indication to interrupt the activity, maintaining display of, via the one or more display generation components, the representation of the software agent.

10. The method of claim 9, wherein, while detecting the activity of the subject, the representation of the software agent is displayed in a first manner, and wherein, while outputting the indication to interrupt the activity, the representation of the software agent is displayed in a second manner different from the first manner.

11. The method of claim 10, wherein the second manner includes a representation of the software agent speaking.

12. The method of claim 1, wherein the indication to interrupt the activity includes audio output.

13. The method of claim 1, wherein the computer system is in communication with one or more movement components, and wherein outputting the indication to interrupt the activity includes moving, via the one or more movement components, a portion of the computer system in a third manner.

14. The method of claim 1, wherein the computer system is in communication with one or more display components, and wherein outputting the indication to interrupt the activity includes displaying, via the one or more display components, visual output.

15. The method of claim 1, wherein the indication to interrupt the activity includes an identification of the activity.

16. The method of claim 1, wherein the indication to interrupt the activity includes an identification of the subject.

17. The method of claim 1, wherein the indication to interrupt the activity includes an identification of a previous interaction with the computer system.

18. The method of claim 1, wherein the indication to interrupt the activity includes an identification of a previous result of previously performing the activity.

19. The method of claim 1, wherein the computer system is in communication with one or more display components, further comprising:
while detecting the activity of the subject, displaying, via the one or more display components, an indication of the activity.

20. The method of claim 1, wherein the computer system is in communication with one or more movement components, the method further comprising:
while detecting the activity of the subject, detecting via the one or more input devices, the subject move from a first position to a second position different from the first position; and
in response to detecting the subject move from the first position to the second position and while detecting the activity of the subject, moving, via the one or more movement components, a portion of the computer system from a third position to a fourth position different from the third position.

21. The method of claim 1, wherein the computer system is in communication with one or more movement components, the method further comprising:
in conjunction with outputting the indication to interrupt the activity, moving, via the one or more movement components, a portion of the computer system so that the portion of the computer system faces the subject.

22. The method of claim 1, wherein the activity is a first activity, the method further comprising:
after forgoing output of the indication to interrupt the activity, detecting, via the one or more input devices, a second activity of the subject, wherein the second activity of the subject is different from the first activity of the subject; and
in response to detecting the second activity of the subject:
in accordance with a determination that the second activity corresponds to a third activity that satisfies the set of one or more criteria, outputting, via the one or more output devices, an indication to interrupt the third activity, wherein the third activity is separate from the second activity; and
in accordance with a determination that the second activity does not satisfy the set of one or more criteria and that the second activity does not correspond to an activity that satisfies the set of one or more criteria, forgoing output of, via the one or more output devices, the indication to interrupt the third activity.

23. A non-transitory computer-readable storage medium storing one or more programs configured to be executed by one or more processors of a computer system that is in communication with one or more input devices and one or more output devices, the one or more programs including instructions for:
detecting, via the one or more input devices, an activity of a subject; and
in response to detecting the activity of the subject:
in accordance with a determination that the activity satisfies a set of one or more criteria, outputting, via the one or more output devices, an indication to interrupt the activity; and
in accordance with a determination that the activity does not satisfy the set of one or more criteria, forgoing output of, via the one or more output devices, the indication to interrupt the activity.

24. A computer system configured to communicate with one or more input devices and one or more output devices, the computer system comprising:
one or more processors; and
memory storing one or more programs configured to be executed by the one or more processors, the one or more programs including instructions for:
detecting, via the one or more input devices, an activity of a subject; and
in response to detecting the activity of the subject:
in accordance with a determination that the activity satisfies a set of one or more criteria, outputting, via the one or more output devices, an indication to interrupt the activity; and
in accordance with a determination that the activity does not satisfy the set of one or more criteria, forgoing output of, via the one or more output devices, the indication to interrupt the activity.
